(19) United States
(12) Patent Application Publication
(10) Pub. No.: US 2005/0094644 A1
(43) Pub. Date: May 5, 2005

(54) Nonblocking and deterministic multirate unicast packet scheduling

(76) Inventor: Venkat Konda, San Jose, CA (US)

Correspondence Address: TEAK NETWORKS, INC., 6278 GRAND OAK WAY, SAN JOSE, CA, 95135, US

(21) Appl. No.: 10/977,215

(22) Filed: Oct. 29, 2004

Related U.S. Application Data
(60) Provisional application No. 60/516,163, filed on Oct. 30, 2003.

(51) Int. Cl. H04L 12/28; H04L 12/56

(52) U.S. Cl. 370/395.4; 370/415

(57) ABSTRACT

A system for scheduling multirate unicast packets through an interconnection network having a plurality of input ports, a plurality of output ports, and a plurality of input queues, comprising multirate unicast packets with rate weight, at each input port is operated in nonblocking manner in accordance with the invention by scheduling corresponding to the packet rate weight, at most as many packets equal to the number of input queues from each input port to each output port. The system is operated at 100% throughput, work conserving, fair, and yet deterministically thereby never congesting the output ports. The system performs arbitration in only one iteration, with mathematical minimum speedup in the interconnection network. The system operates with absolutely no packet reordering issues, no internal buffering of packets in the interconnection network, and hence in a truly cut-through and distributed manner. In another embodiment each output port also comprises a plurality of output queues and each packet is transferred corresponding to the packet rate weight, to an output queue in the destined output port in deterministic manner and without the requirement of segmentation and reassembly of packets even when the packets are of variable size. In one embodiment the scheduling is performed in strictly nonblocking manner with a speedup of at least two in the interconnection network. In another embodiment the scheduling is performed in rearrangeably nonblocking manner with a speedup of at least one in the interconnection network. The system also offers end to end guaranteed bandwidth and latency for multirate packets from input ports to output ports. In all the embodiments, the interconnection network may be a crossbar network, shared memory network, clos network, hypercube network, or any internally nonblocking interconnection network or network of networks.

### CROSS REFERENCE TO RELATED APPLICATIONS

This application is related to and claims priority of U.S. Provisional Patent Application Ser. No. 60/516,163, filed on 30, Oct. 2003. This application is U.S. patent application to and incorporates by reference in its entirety the related PCT application Docket No. S-0009 entitled “NONBLOCKING AND DETERMINISTIC MULTIRATE UNICAST PACKET SCHEDULING” by Venkat Konda assigned to the same assignee as the current application, and filed concurrently. This application is related to and incorporates by reference in its entirety the related U.S. patent application Ser. No. 09/967,815 entitled “REARRANGEABLY NON-BLOCKING MULTICAST MULTI-STAGE NETWORKS” by Venkat Konda assigned to the same assignee as the current application, filed on 27, Sep. 2001 and its Continuation In Part PCT application Ser. No. 03/27971 filed on 6, Sep. 2003. This application is related to and incorporates by reference in its entirety the related U.S. patent application Ser. No. 09/967,106 entitled “STRICTLY NON-BLOCKING MULTICAST MULTI-STAGE NETWORKS” by Venkat Konda assigned to the same assignee as the current application, filed on 27, Sep. 2001 and its Continuation In Part PCT application Ser. No. 03/27972 filed on 6, Sep. 2003.

This application is related to and incorporates by reference in its entirety the related U.S. Provisional Patent Application Ser. No. 60/500,790 filed on 6, Sep. 2003 and its U.S. patent application Ser. No. 10/933,899 as well as its PCT application Ser. No. 04/29043 filed on 5, Sep. 2004. This application is related to and incorporates by reference in its entirety the related U.S. Provisional Patent Application Ser. No. 60/500,789 filed on 6, Sep. 2003 and its U.S. patent application Ser. No. 10/933,900 as well as its PCT application Ser. No. 04/29027 filed on 5, Sep. 2004.

This application is related to and incorporates by reference in its entirety the related U.S. Provisional Patent Application Ser. No. 60/516,057, filed 30, Oct. 2003 and its U.S. patent application Docket No. V-0005 as well as its PCT application Docket No. S-0005 filed concurrently. This application is related to and incorporates by reference in its entirety the related U.S. Provisional Patent Application Ser. No. 60/516,265, filed 30, Oct. 2003 and its U.S. patent application Docket No. V-0006 as well as its PCT application Docket No. S-0006 filed concurrently. This application is related to and incorporates by reference in its entirety the related U.S. Provisional Patent Application Ser. No. 60/515,985, filed 30, Oct. 2003 and its U.S. patent application Docket No. V-0010 as well as its PCT application Docket No. S-0010 filed concurrently.

### BACKGROUND OF INVENTION

Today's ATM switches and IP routers typically employ many types of interconnection networks to switch packets from input ports (also called “ingress ports”) to the desired output ports (also called “egress ports”). To switch the packets through the interconnection network, they are queued either at input ports, or output ports, or at both input and output ports. A packet may be destined to one or more output ports. A packet that is destined to only one output port is called unicast packet, a packet that is destined to more than one output port is called multicast packet, and a packet that is destined to all the output ports is called broadcast packet.

Output-queued (OQ) switches employ queues only at the output ports. In output-queued switches when a packet is received on an input port it is immediately switched to the destined output port queues. Since the packets are immediately transferred to the output port queues, in an r*r output-queued switch it requires a speedup of r in the interconnection network. Input-queued (IQ) switches employ queues only at the input ports. Input-queued switches require a speedup of only one in the interconnection network; Alternatively in IQ switches no speedup is needed. However input-queued switches do not eliminate Head of line (HOL) blocking, meaning if the destined output port of a packet at the head of line of an input queue is busy at a switching time, it also blocks the next packet in the queue even if its destined output port is free.

Combined-input-and-output queued (CIOQ) switches employ queues at both its input and output ports. These switches achieve the best of the both OQ and IQ switches by employing a speedup between 1 and r in the interconnection network. Another type of switches called Virtual-output-queued (VOQ) switches is designed with r queues at each input port, each corresponding to packets destined to one of each output port. VOQ switches eliminate HOL blocking.

VOQ switches have received a great attention in the recent years. An article by Nick Mckeown entitled, “The iSLIP Scheduling Algorithm for Input-Queued Switches”, IEEE/ACM Transactions on Networking, Vol. 7, No. 2, April 1999 is incorporated by reference herein as background of the invention. This article describes a number of scheduling algorithms for crossbar based interconnection networks in the introduction section on page 188 to page 190.

U.S. Pat. No. 6,212,182 entitled “Combined Unicast and Multicast Scheduling” granted to Nick Mckeown that is incorporated by reference as background describes a VOQ switching technique with r unicast queues and one multicast queue at each input port. At each switching time, an iterative arbitration is performed to switch one packet to each output port.

U.S. Pat. No. 6,351,466 entitled “Switching Systems and Methods of Operation of Switching Systems” granted to Prabhakar et al. that is incorporated by reference as background describes a VOQ switching technique in a crossbar interconnection network with r unicast queues at each input port and one queue at each output port requires a speedup of at least four performs as if it were output-queued switch including the accurate control of packet latency.

However there are many problems with the prior art of switch fabrics. First, HOL blocking for multicast packets is not eliminated. Second, mathematical minimum speedup in the interconnection is not known. Third, speedup in the interconnection network is used to flood the output ports, which creates unnecessary packet congestion in the output ports, and rate reduction to transmit packets out of the egress ports. Fourth, arbitrary fan-out multicast packets are not scheduled in nonblocking manner to the output ports. Fifth, at each switching time packet arbitration is performed iteratively that is expensive in switching time, cost and power. Sixth and lastly, the current art performs scheduling in greedy and non-deterministic manner and thereby requiring segmentation and reassembly at the input and output ports.

### SUMMARY OF INVENTION

A system for scheduling multirate unicast packets through an interconnection network having a plurality of input ports, a plurality of output ports, and a plurality of input queues, comprising multirate unicast packets with rate weight, at each input port is operated in nonblocking manner in accordance with the invention by scheduling corresponding to the packet rate weight, at most as many packets equal to the number of input queues from each input port to each output port. The system is operated at 100% throughput, work conserving, fair, and yet deterministically thereby never congesting the output ports. The system performs arbitration in only one iteration, with mathematical minimum speedup in the interconnection network. The system operates with absolutely no packet reordering issues, no internal buffering of packets in the interconnection network, and hence in a truly cut-through and distributed manner. In another embodiment each output port also comprises a plurality of output queues and each packet is transferred corresponding to the packet rate weight, to an output queue in the destined output port in deterministic manner and without the requirement of segmentation and reassembly of packets even when the packets are of variable size. In one embodiment the scheduling is performed in strictly nonblocking manner with a speedup of at least two in the interconnection network. In another embodiment the scheduling is performed in rearrangeably nonblocking manner with a speedup of at least one in the interconnection network. The system also offers end to end guaranteed bandwidth and latency for multirate packets from input ports to output ports. In all the embodiments, the interconnection network may be a crossbar network, shared memory network, clos network, hypercube network, or any internally nonblocking interconnection network or network of networks.

### BRIEF DESCRIPTION OF DRAWINGS

FIG. 1A is a diagram of an exemplary four by four port switch fabric with input and output multirate unicast queues containing short packets and a speedup of two in the crossbar based interconnection network, in accordance with the invention; FIG. 1B is a high-level flowchart of an arbitration and scheduling method 40, according to the invention, used to switch packets from input ports to output ports; FIG. 1C is a diagram of a three-stage network similar in scheduling switch fabric 10 of FIG. 1A; FIG. 1D, FIG. 1E, FIG. 1F, FIG. 1G, and FIG. 1H show the state of switch fabric 10 of FIG. 1A, after nonblocking and deterministic packet switching, in accordance with the invention, in five consecutive switching times.

FIG. 1I shows a diagram of an exemplary four by four port switch fabric with input and output multirate unicast queues containing long packets and a speedup of two in the crossbar based interconnection network, in accordance with the invention; FIG. 1J, FIG. 1K, FIG. 1L, and FIG. 1M show the state of switch fabric 16 of FIG. 1I, after nonblocking and deterministic packet switching without segmentation and reassembly of packets, in accordance with the invention, after four consecutive fabric switching cycles; FIG. 1N is a diagram of an exemplary four by four port switch fabric with input and output multirate unicast queues and no speedup in the crossbar based interconnection network, in accordance with the invention.

FIG. 2A is a diagram of an exemplary four by four port switch fabric with input multirate unicast queues and a speedup of two in the crossbar based interconnection network, in accordance with the invention; FIG. 2B, FIG. 2C, FIG. 2D, FIG. 2E, and FIG. 2F show the state of switch fabric 20 of FIG. 2A, after nonblocking and deterministic packet switching, in accordance with the invention, in five consecutive switching times.

FIG. 3A is a diagram of an exemplary four by four port switch fabric with input and output multirate unicast queues, and a speedup of two in link speed and clock speed in the crossbar based interconnection network, in accordance with the invention; FIG. 3B is a diagram of an exemplary four by four port switch fabric with input and output multirate unicast queues and a speedup of two in the shared memory based interconnection network, in accordance with the invention; FIG. 3C is a diagram of an exemplary four by four port switch fabric with input and output multirate unicast queues, and a speedup of two in link speed and clock speed in the shared memory based interconnection network, in accordance with the invention; FIG. 3D is a diagram of an exemplary four by four port switch fabric with input and output multirate unicast queues and a speedup of two in the hypercube based interconnection network, in accordance with the invention; FIG. 3E is a diagram of an exemplary four by four port switch fabric with input and output multirate unicast queues, and a speedup of two in link speed and clock speed in the hypercube based interconnection network, in accordance with the invention.

FIG. 4A is a diagram of a general r*r port switch fabric with input and output multirate unicast queues and a speedup of two in the crossbar based interconnection network, in accordance with the invention; FIG. 4B is a diagram of a general r*r port switch fabric with input and output multirate unicast queues, and a speedup of two in link speed and clock speed in the crossbar based interconnection network, in accordance with the invention; FIG. 4C is a diagram of a general r*r port switch fabric with input and output multirate unicast queues and a speedup of two in the shared memory based interconnection network, in accordance with the invention; FIG. 4D is a diagram of a general r*r port switch fabric with input and output multirate unicast queues, and a speedup of two in link speed and clock speed in the shared memory based interconnection network, in accordance with the invention; FIG. 4E is a diagram of a general r*r port switch fabric with input and output multirate unicast queues and a speedup of two in the three-stage clos network based interconnection network, in accordance with the invention; FIG. 4F is a diagram of a general r*r port switch fabric with input and output multirate unicast queues, and a speedup of two in link speed and clock speed in the three-stage clos network based interconnection network, in accordance with the invention; FIG. 4G shows a detailed diagram of a four by four port (2-rank) hypercube based interconnection network in one embodiment of the middle stage interconnection network 131 or 132 in switch fabric 70 of FIG. 3D and switch fabric 80 of FIG. 3E.

FIG. 5A is an intermediate level implementation of the act 44 of the arbitration and scheduling method 40 of FIG. 1B; FIG. 5B is a low-level flow chart of one variant of act 44 of FIG. 5A.

### DETAILED DESCRIPTION OF THE INVENTION

The present invention is concerned about the design and operation of nonblocking and deterministic scheduling in switch fabrics regardless of the nature of the traffic, comprising multirate unicast and multirate multicast packets, arriving at the input ports. Specifically the present invention is concerned about the following issues in packet scheduling systems: 1) Strictly and rearrangeably nonblocking of packet scheduling; 2) Deterministically switching the multirate packets, based on rate weight, from input ports to output ports (if necessary to specific output queues at output ports) i.e., without congesting output ports; 3) Without requiring the implementation of segmentation and reassembly (SAR) of the packets; 4) Arbitration in only one iteration; 5) Using mathematical minimum speedup in the interconnection network; and 6) yet operating at 100% throughput even when the packets are of variable size.

When a packet at an input port is destined to more than one output ports, it requires one-to-many transfer of the packet and the packet is called a multicast packet. When a packet at an input port is destined to only one output port, it requires one-to-one transfer of the packet and the packet is called a unicast packet. When a packet at an input port is destined to all output ports, it requires one-to-all transfer of the packet and the packet is called a broadcast packet. A set of unicast packets to be transferred through an interconnection network is referred to as a unicast assignment.

The switch fabrics of the type described herein employ virtual output queues (VOQ) at input ports. In one embodiment, the packets received at each input port are arranged into as many queues as there are output ports. Each queue holds packets that are destined to only one of the output ports. However packets in each input queue carry data at arbitrarily different rates, with the rate weight of the packets denoting the rate of packets. The rate weight of the packets in an input queue is denoted by a positive integer. For example, the packets with a rate weight of two, in an input queue are switched to the output ports at two times faster rate than the packets with a rate weight of one, in another input queue. The switch fabric may or may not have output queues at the output ports. When there are output queues, in one embodiment, there will be as many queues at each output port as there are input ports. The packets, irrespective of the rate weight, are switched to output queues so that each output queue holds packets switched from only one input port.

In certain switch fabrics of the type described herein, each input queue in all the input ports, having multirate unicast packets, allocate different bandwidth in the output ports, depending on the rate weight of packets at the input queues. The current invention is concerned about the design and scheduling of nonbocking and deterministic switch fabrics for such multirate unicast packets. The nonblocking and deterministic switch fabrics with each input queue in all the input ports, having unicast packets with constant rates, allocate equal bandwidth in the output ports are described in detail in U.S. patent application, Attorney Docket No. V-0005 that is incorporated by reference above.

The nonblocking and deterministic switch fabrics with each input queue in all the input ports, having multicast packets with constant rates, allocate equal bandwidth in the output ports are described in detail in U.S. patent application, Attorney Docket No. V-0006 that is incorporated by reference above. The nonblocking and deterministic switch fabrics with the each input queue, having multirate multicast packets, allocate different bandwidth in the output ports are described in detail in U.S. patent application, Attorney Docket No. V-0010 that is incorporated by reference above.

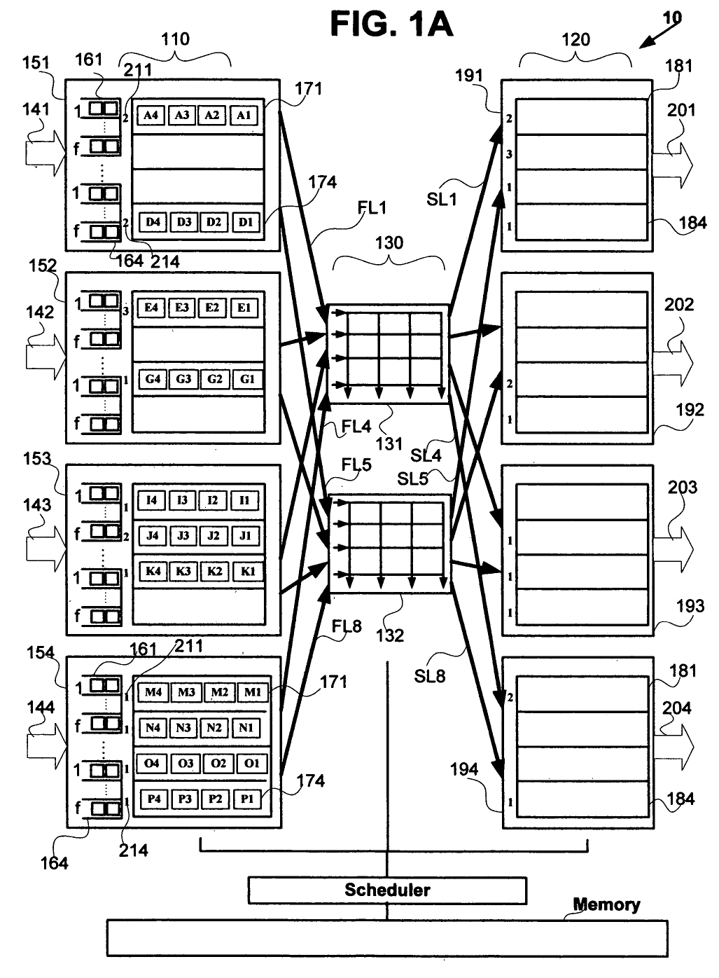

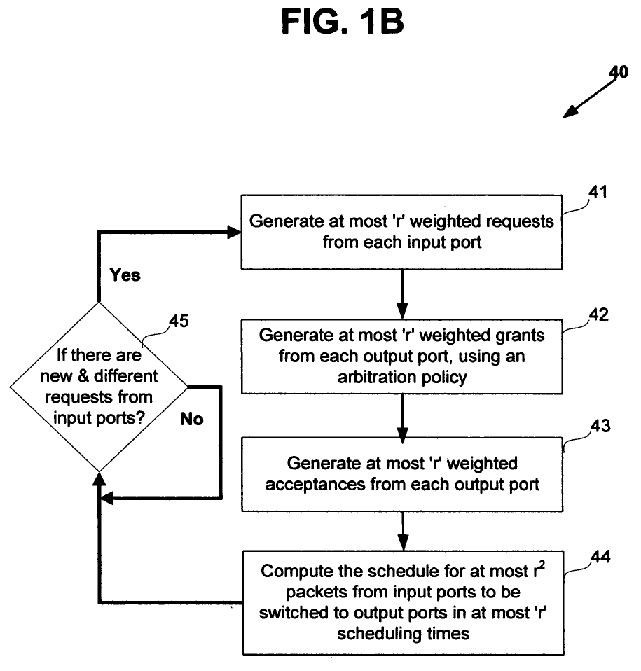

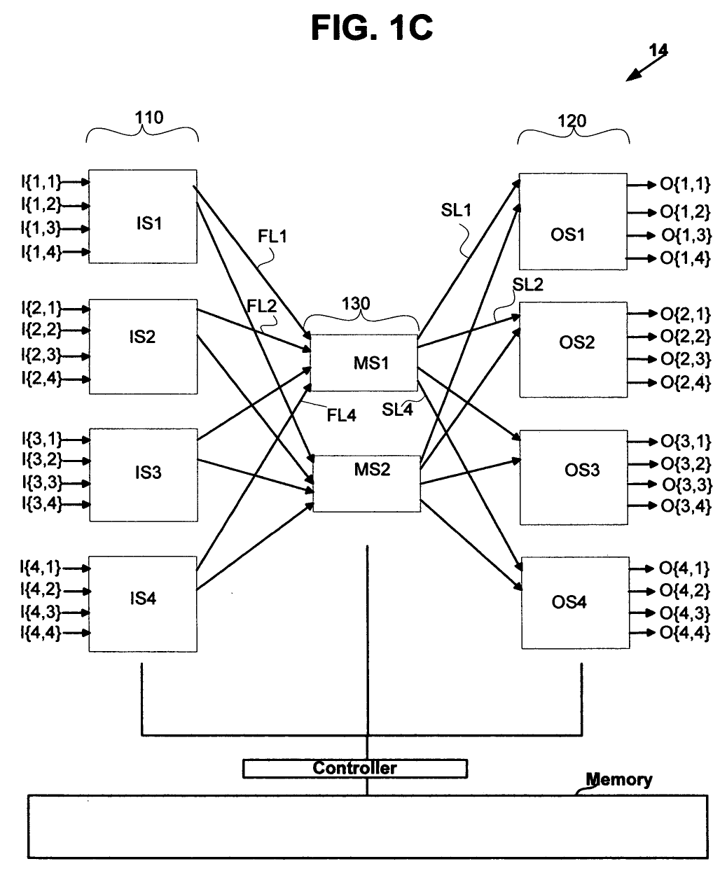

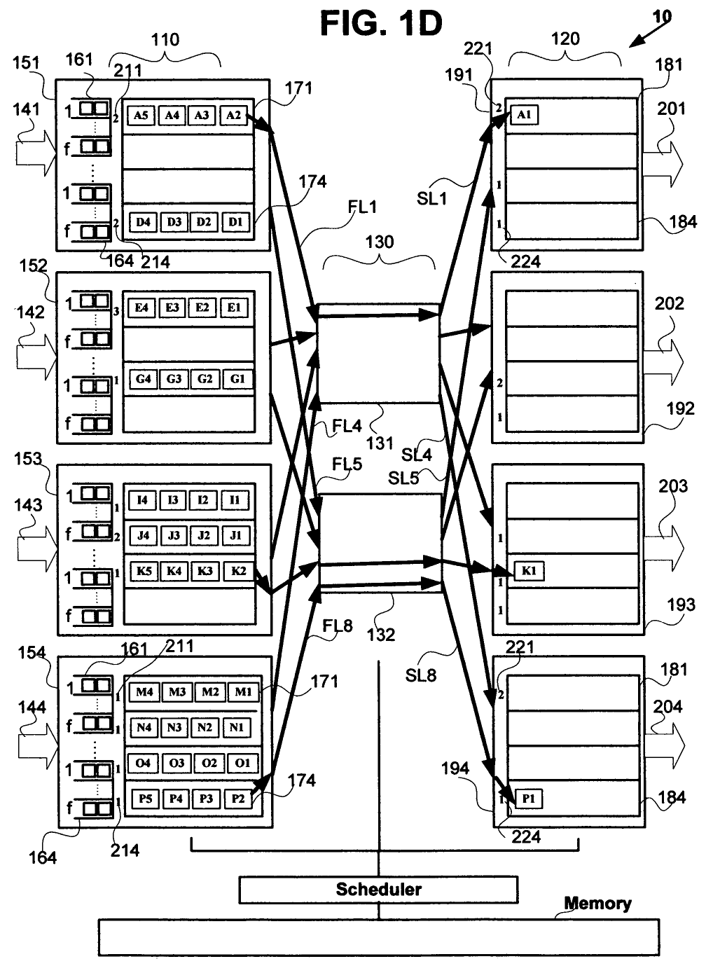

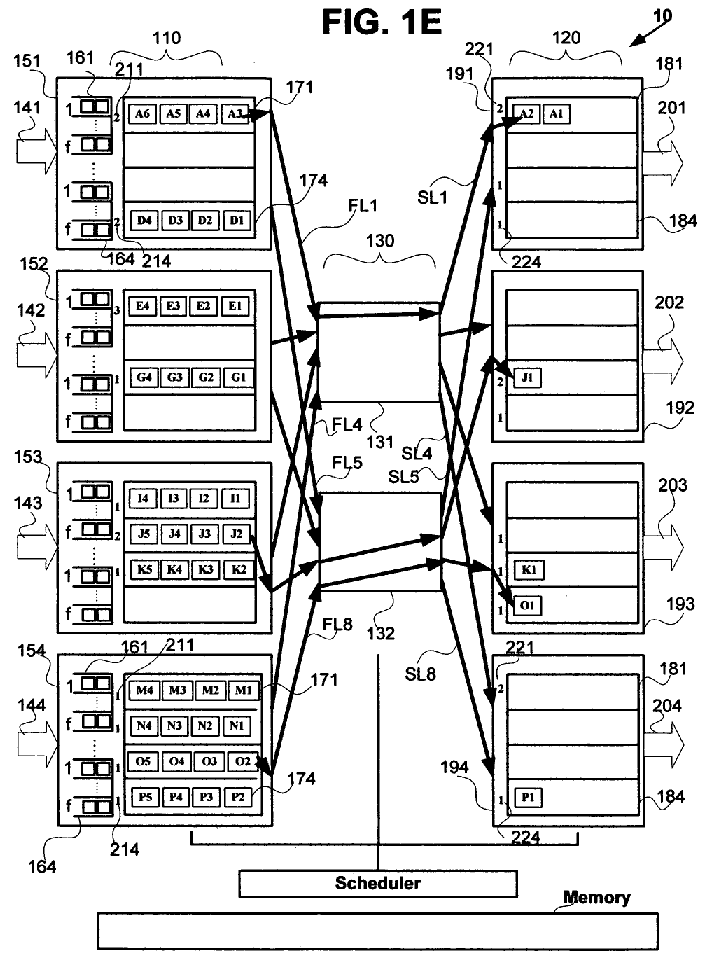

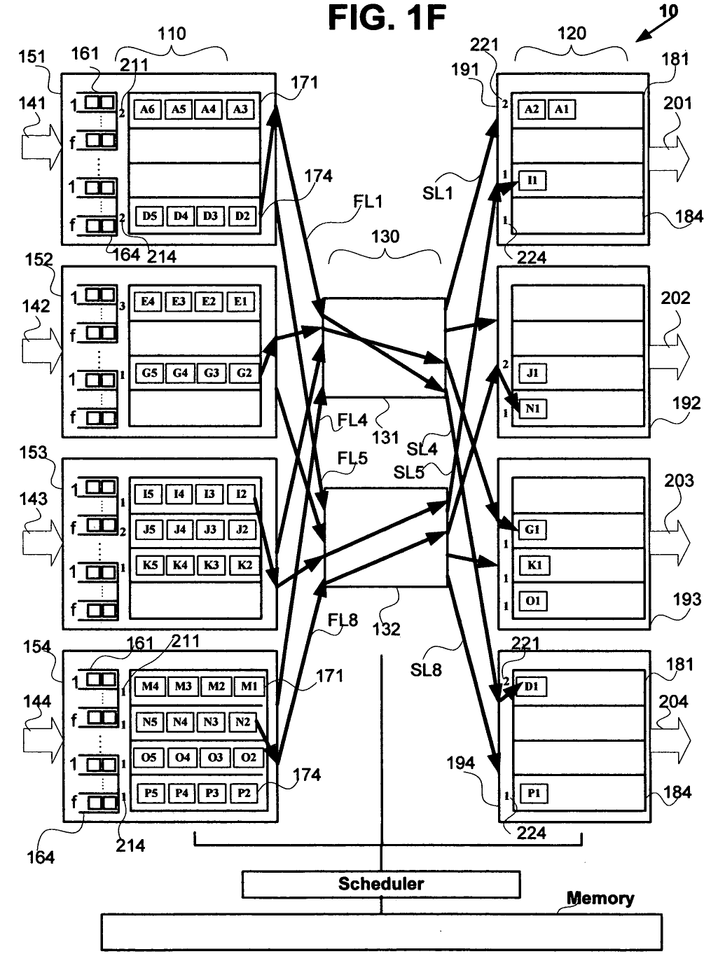

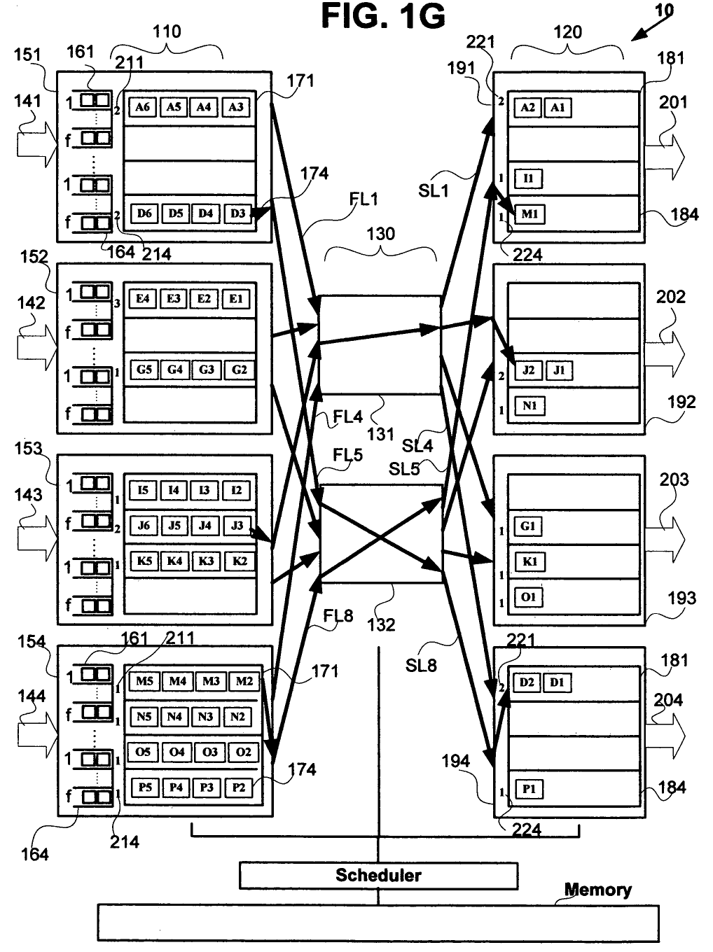

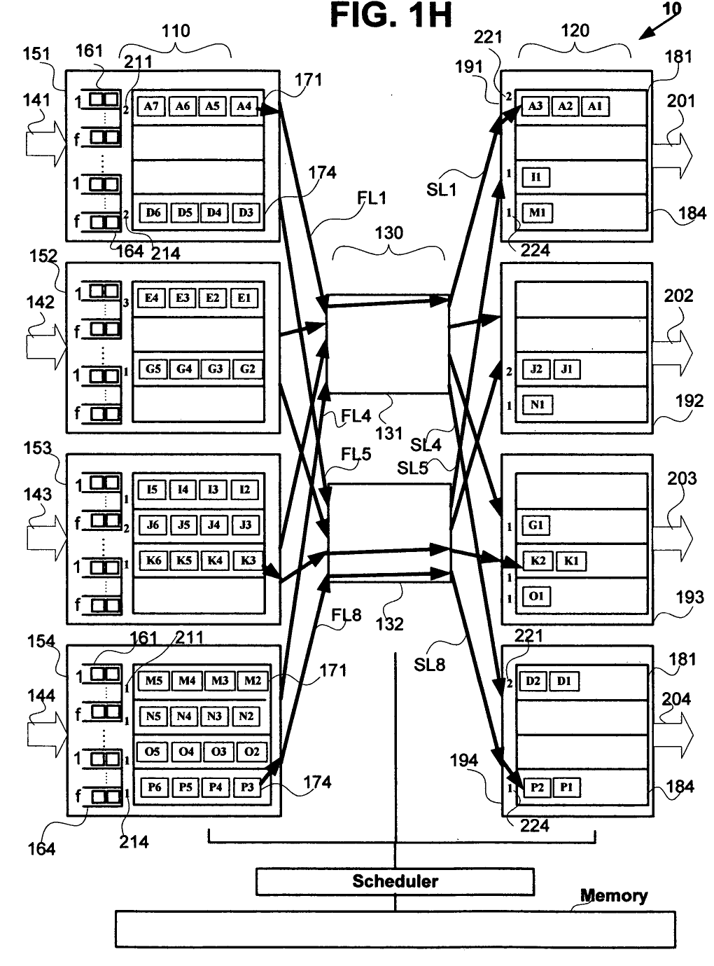

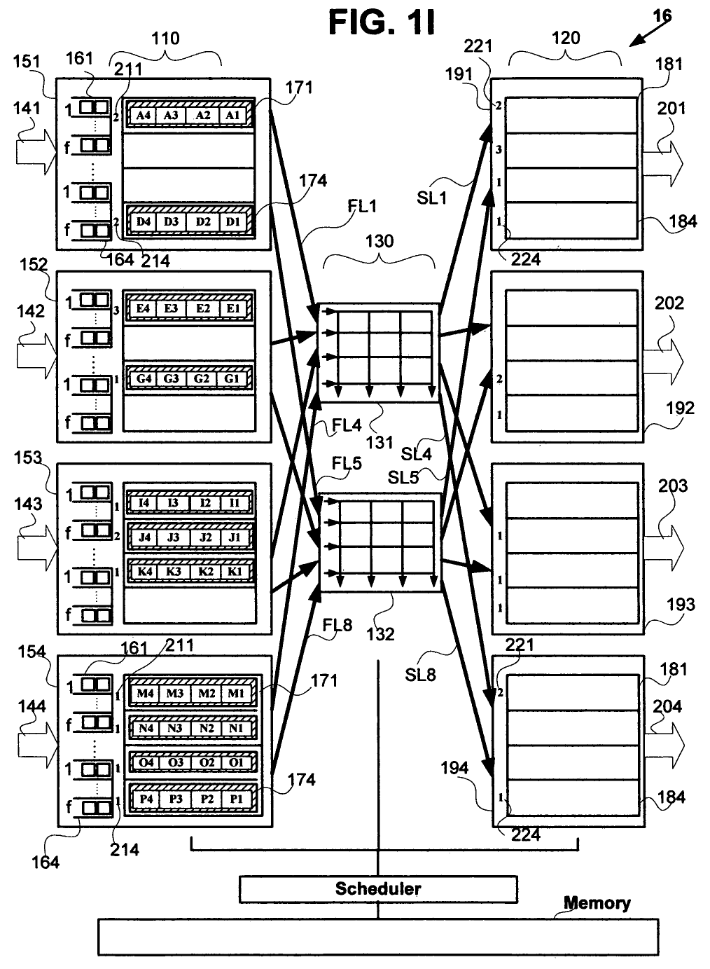

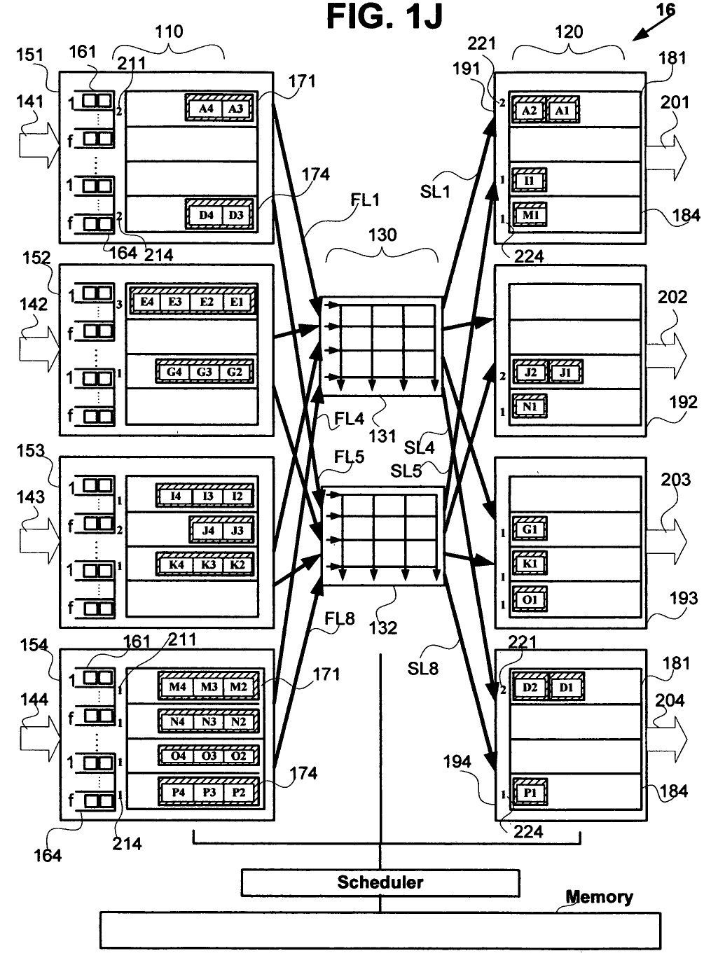

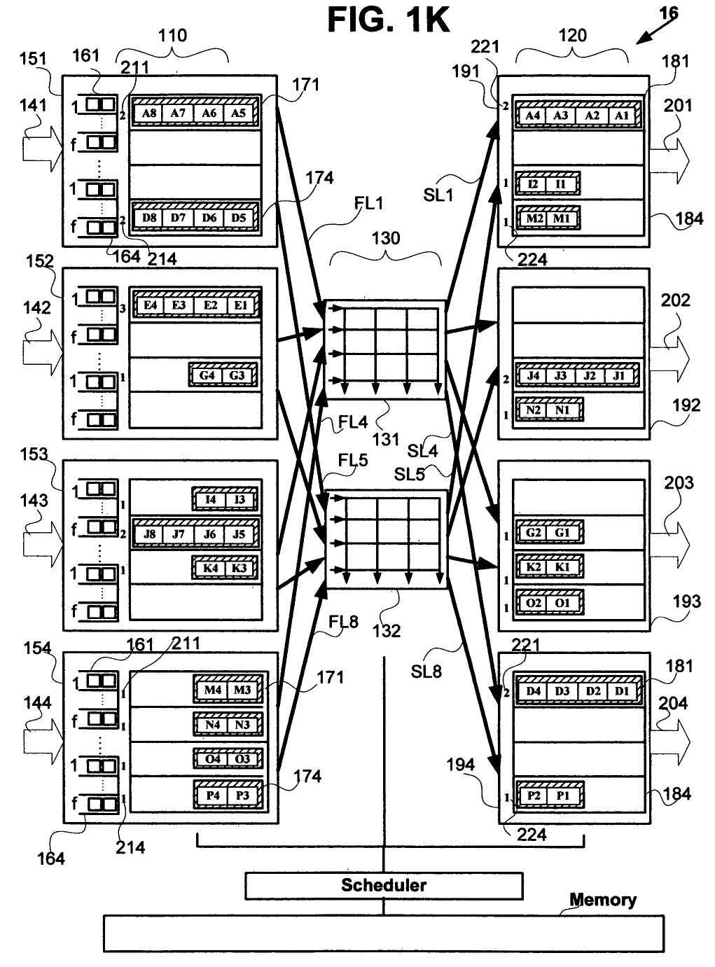

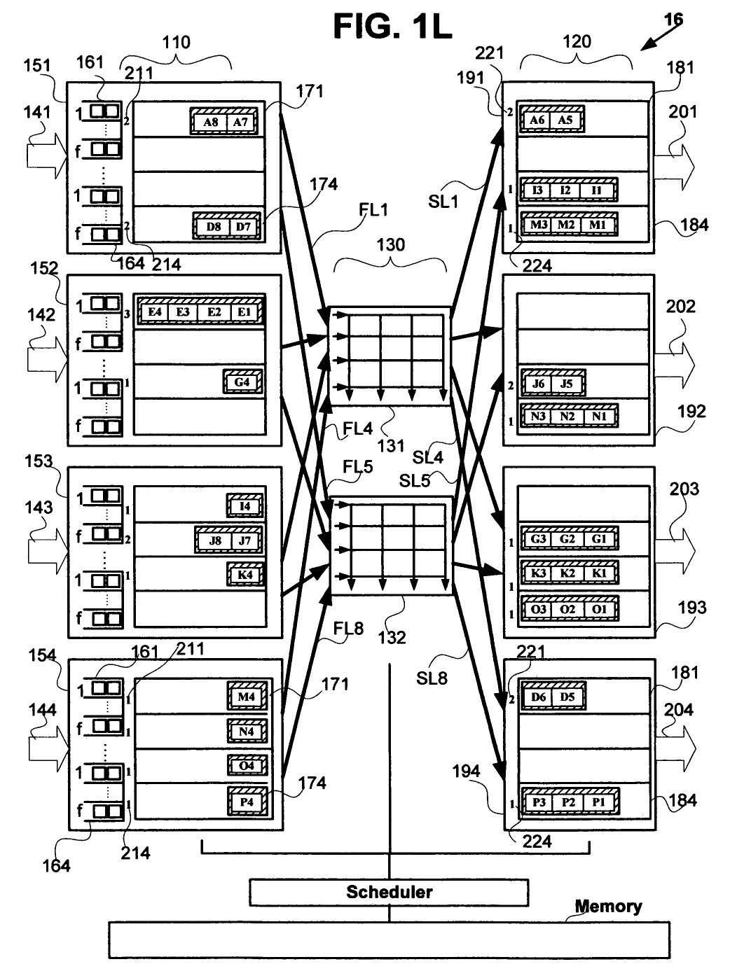

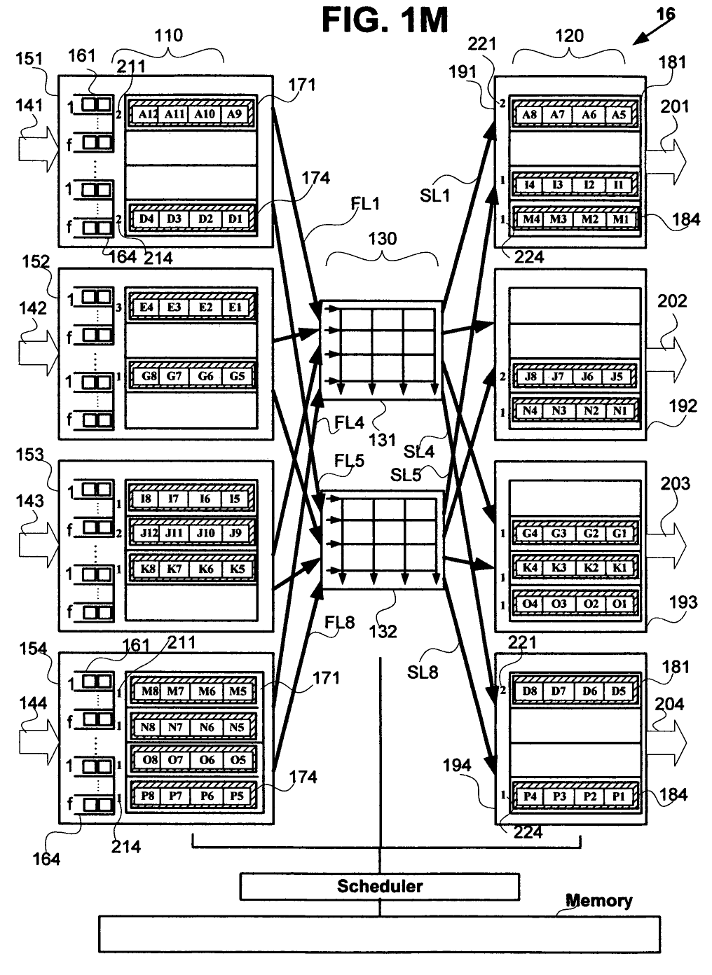

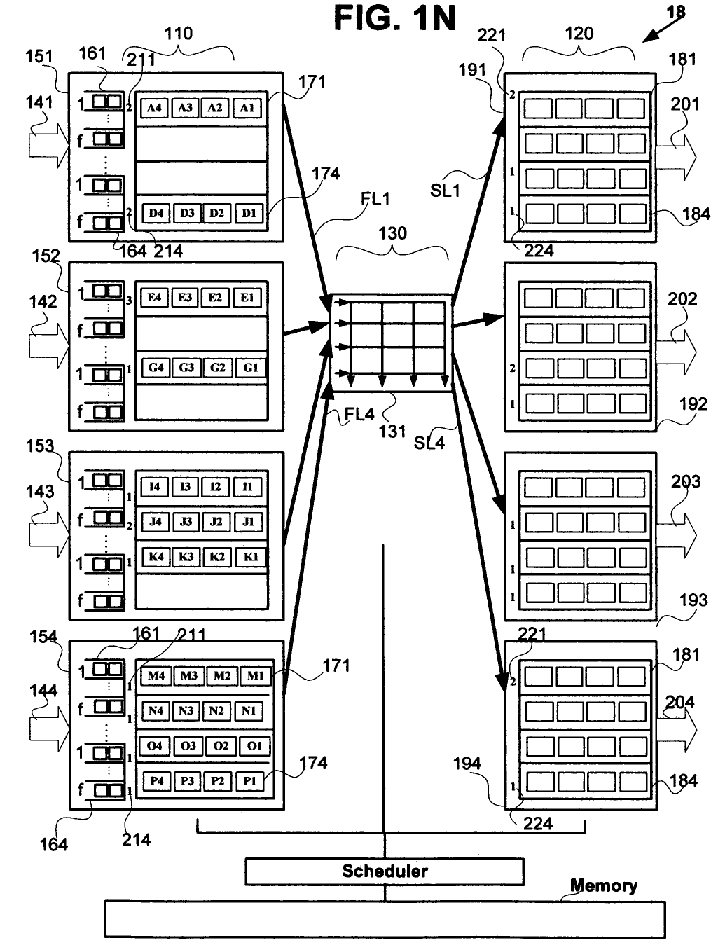

Referring to FIG. 1A, an exemplary switch fabric 10 with an input stage 110 consists of four input ports 151-154 and an output stage 120 consists of four output ports 191-194 via a middle stage 130 of an interconnection network consists of two four by four crossbar networks 131-132. Each input port 151-154 receives multirate unicast packets through the inlet links 141-144 respectively. Each out port 191-194 transmits multirate unicast packets through the outlet links 201-204 respectively. Each crossbar network 131-132 is connected to each of the four input ports 151-154 through eight links (hereinafter “first internal links”) FL1-FL8, and is also connected to each of the four output ports 191-194 through eight links (hereinafter “second internal links”) SL1-SL8. In switch fabric 10 of FIG. 1A each of the inlet links 141-144, first internal links FL1-FL8, second internal links SL1-SL8, and outlet links 201-204 operate at the same rate.

At each input port 151-154 multirate unicast packets received through the inlet links 141-144 are sorted according to their destined output port into as many input queues 171-174 (four) as there are output ports so that packets destined to output ports 191-194 are placed in input queues 171-174 respectively in each input port 151-154. In one embodiment, as shown in switch fabric 10 of FIG. 1A, before the multirate unicast packets are placed in input queues they may also be placed in prioritization queues 161-164. Each prioritization queue 161-164 contains f queues holding multirate unicast packets corresponding to the priority of [1-f]. For example the packets destined to output port 191 are placed in the prioritization queue 161 based on the priority of the packets [1-f], and the highest priority packets are placed in input queue 171 first before the next highest priority packet is placed. The usage of priority queues 161-164 is not relevant to the operation of switch fabric 10, and so switch fabric 10 in FIG. 1A can also be implemented without the prioritization queues 161-164 in another embodiment. (The usage of priority queues is not relevant to all the embodiments described in the current invention and so all the embodiments can also be implemented without the prioritization queues in nonblocking and deterministic manner.)

The network also includes a scheduler coupled with each of the input stage 110, output stage 120 and middle stage 130 to switch packets from input ports 151-154 to output ports 191-194. The scheduler maintains in memory a list of available destinations for the path through the interconnection network in the middle stage 130.

In one embodiment, as shown in FIG. 1A, each output port 191-194 consists of as many output queues 181-184 as there are input ports (four), so that packets switched from input ports 151-154 are placed in output queues 181-184 respectively in each output port 191-194. Each input queue 171-174 in the four input ports 151-154 in switch fabric 10 of FIG. 1A shows an exemplary four packets with A1-A4 in the input queue 171 of input port 151 and with P1-P4 in the fourth input queue 174 of the input port 164 ready to be switched to the output ports. The head of line packets in all the 16 input queues in the four input ports 151-154 are designated by A1-P1 respectively.

Table 1 shows an exemplary input queue to output queue assignment in switch fabric 10 of FIG. 1A. Packets in input queue 171 in input port 151 denoted by I{1,1} are assigned to be switched to output queue 181 in output port 191 denoted by O{1,1}. Packets in input queue 172 in input port 151 denoted by I{1,2} are assigned to be switched to output queue 181 in output port 192 denoted by O{2,1}. Similarly packets in the rest of 16 input queues are assigned to the rest of 16 output queues as shown in Table 1. Multirate unicast packets from any given input queue are always switched to the same designated output queue as shown in Table 1. In another embodiment, input queue to output queue assignment may be different from Table 1, but in accordance with the current invention, there will be only one input queue in each input port assigned to switch packets to an output queue in each output port and vice versa.

TABLE 1
Input Queue to Output Queue Unicast
Packet Assignment in FIG. 1A

| Packets from | Packets from | Packets from | Packets from |
|---|---|---|---|
| input port 151 | input port 152 | input port 153 | input port 154 |
| I{1,1} [symbol] | I{2,1} [symbol] O{1,2} | I{3,1} [symbol] O{1,3} | I{4,1} [symbol] O{1,4} |
| O{1,1} | | | |
| I{1,2} [symbol] | I{2,2} [symbol] O{2,2} | I{3,2} [symbol] O{2,3} | I{4,2} [symbol] O{2,4} |
| O{2,1} | | | |
| I{1,3} [symbol] | I{2,3} [symbol] O{3,2} | I{3,3} [symbol] O{3,3} | I{4,3} [symbol] O{3,4} |
| O{3,1} | | | |
| I{1,4} [symbol] | I{2,4} [symbol] O{4,2} | I{3,4} [symbol] O{4,3} | I{4,4} [symbol] O{4,4} |
| O{4,1} | | | |

Table 2 shows an exemplary set of multirate unicast packet requests from input queues of the input ports in switch fabric 10 of FIG. 1A. Multirate packets in input queue I{1,1} are assigned to be switched to output queue O{1,1} with a rate weight of 2. There are no packets to be switched from input queues I{1,2} and I{1,3}. Multirate packets in I{1,4} are assigned to be switched to output queue O{4,1} with a rate weight of 2. Similarly among the rest of 16 input queues, only the input queues that have multirate packets assigned an output queue are shown in Table 2. The rate weight of packets from each input queue 171-174 of all the input ports 151-154 is denoted by 211-214 as shown in FIG. 1A.

Applicant observes that the sum of the rate weights of all the input queues in each input port cannot exceed four, since it is a four by four port switch fabric 10 of FIG. 1A. When all the four input queues in each input port allocate equal bandwidth in each output port the rate weight of each input queue is one. And when one of the input queue has a rate weight of more than one, it is at the expense another input queue in the same input port, since each inlet link receives only one packet in each switching time. Hence the total rate weight of all the input queues in each input port cannot exceed more than four (which is the number of output ports) in switch fabric 10 of FIG. 1A. A direct consequence of this observation is that there cannot arise any input port contention in switch fabric 10 of FIG. 1A.

TABLE 2
An Exemplary Set of Packet (Arbitration) Requests generated by the
Input Ports in FIG. 1A
Packet requests from
input port 151
I{1,1} [symbol] O{1,1} [symbol] 2
I{1,4} [symbol] O{4,1} [symbol] 2
Packet requests from
input port 152
I{2,1} [symbol] O{1,2} [symbol] 3
I{2,3} [symbol] O{3,2} [symbol] 1
Packet requests from
input port 153
I{3,1} [symbol] O{1,3} [symbol] 1
I{3,2} [symbol] O{2,3} [symbol] 2
I{3,3} [symbol] O{3,3} [symbol] 1
Packet requests from
input port 154
I{4,1} [symbol] O{1,4} [symbol] 1
I{4,2} [symbol] O{2,4} [symbol] 1
I{4,3} [symbol] O{3,4} [symbol] 1
I{4,4} [symbol] O{4,4} [symbol] 1

Since there is no input port contention, all the 16 head of line packets in all the input ports are switched in four switching times (hereinafter “a fabric switching cycle”), according to the rate weight of the packets, to the output ports, as long as there is no oversubscription of output ports. When there is oversubscription of output ports, one or more input queues that are not granted switching by the output ports will not switch packets to the output ports.

Whether there are packets with rate weight of more than one in an input queue or not, only four packets will be switched to the output ports in a fabric switching cycle (or equivalently in four switching times) in the switch fabric 10 of FIG. 1A. If all the four input queues have rate weight of one then the four packets switched, in a fabric switching cycle, are from all four input queues, where as if one or more of the four input queues have rate weight of more than one, an input queue switches as many packets to the output port as denoted by the rate weight in a fabric switching cycle, so that only four packets in total will be switched from an input port.

FIG. 1B shows an arbitration and scheduling method, in accordance with the current invention, in one embodiment with two four by four crossbar networks 131-132 in the middle stage 130, i.e., with a speedup of at least two, to operate switch fabric 10 of FIG. 1A in strictly nonblocking and deterministic manner. The specific method used in implementing the strictly non-blocking and deterministic switching can be any of a number of different methods that will be apparent to a skilled person in view of the disclosure. One such arbitration and scheduling method is described below in reference to FIG. 1B.

The arbitration part of the method 40 of FIG. 1B (described in detail later) comprises three steps: namely the generation of requests by the input ports, the issuance of grants by the output ports and the acceptance of the grants by the input ports. Since there is no input port contention, the set of packet requests shown in Table 2 is also the set of packet arbitration requests generated by input ports of switch fabric 10 of FIG. 1A.

Applicant observes that in switch fabric 10 of FIG. 1A there arises output port contention, particularly when there is oversubscription of the output ports. In the same manner, an inlet link receives at most one packet in each switching time, an outlet link transmits at most one packet in each switching time. Also each input port switches at most one packet into the destined output ports and each output port receives at most one packet from the input port in each switching time. And hence in each fabric switching cycle, an output port receives at most four packets in the four by four port switch fabric 10 of FIG. 1A. Therefore the sum of the rate weights of all the requests received from the input ports that can be satisfied by each output port is at most four in a fabric switching cycle.

Alternatively if the sum of the rate weights of all the packet requests is more than four in an output port, it means that output port is oversubscribed. Applicant also notes that out of all the four packets that an output port can receive in a fabric switching cycle, more than one packet may be received from the same input queue in an input port, i.e., when the rate weight of the packets from that input queue is more than one. Table 3 shows the set of multirate unicast packet requests received by output queues of the output ports in switch fabric 10 of FIG. 1A corresponding to the packet requests generated by input ports as shown in Table 2.

TABLE 3
Packet Arbitration Requests received by the Output Ports in FIG. 1A
corresponding to the Requests of TABLE 2
Packet requests to
output port 191
I{1,1} [symbol] O{1,1} [symbol] 2
I{2,1} [symbol] O{1,2} [symbol] 3
I{3,1} [symbol] O{1,3} [symbol] 1
I{4,1} [symbol] O{1,4} [symbol] 1
Packet requests to
output port 192
I{3,2} [symbol] O{2,3} [symbol] 2
I{4,2} [symbol] O{2,4} [symbol] 1
Packet requests to
output port 193
I{2,3} [symbol] O{3,2} [symbol] 1
I{3,3} [symbol] O{3,3} [symbol] 1
I{4,3} [symbol] O{3,4} [symbol] 1
Packet requests to
output port 194
I{1,4} [symbol] O{4,1} [symbol] 2
I{4,4} [symbol] O{4,4} [symbol] 1

As shown in Table 3, the sum of the rate weights of all the requested output queues in each output port 191-194 is 7, 3, 3, and 3 respectively. Clearly output port 191 is oversubscribed. Output ports 192-194 are not oversubscribed and so they will grant all the requests to the respective input ports. When there is an oversubscription at an output port only four requests are granted based on an output port contention resolution policy. In one embodiment, as shown in Table 4, output port 191 issues grants to input ports 151, 153, and 154 and thus limiting the sum of the rate weights of all the requests to four. Since each input port generated requests with the sum of all the requests at most four in the first arbitration step, the sum of the rate weights of all grants in each input port will never be more than four. Hence the grants issued by the output ports will directly become the acceptances by the input ports, as shown in Table 4.

In another embodiment, output port 191 issues grants so that each of the four requests is granted at a rate weight of one. However it will reduce the rate weight of all the requests. Similarly a variety of policies can be used to the issuance of grants when an output port is oversubscribed. The type of policy used to resolve the oversubscription of an output port is irrelevant to the operation of switch fabric 10 of FIG. 1A, and no matter what type of oversubscription resolution policy is used switch fabric 10 of FIG. 1A is always operated in nonblocking and deterministic manner in accordance with the current invention.

TABLE 4
Packet Arbitration Grants and Acceptances in FIG. 1A corresponding
to the Requests of TABLE 3
Packet acceptances from
Input port 151
I{1,1} [symbol] O{1,1} [symbol] 2
I{1,4} [symbol] O{4,1} [symbol] 2
Packet acceptances from
input port 152
I{2,3} [symbol] O{3,2} [symbol] 1
Packet acceptances from
Input port 153
I{3,1} [symbol] O{1,3} [symbol] 1
I{3,2} [symbol] O{2,3} [symbol] 2
I{3,3} [symbol] O{3,3} [symbol] 1
Packet acceptances from
input port 154
I{4,1} [symbol] O{1,4} [symbol] 1
I{4,2} [symbol] O{2,4} [symbol] 1
I{4,3} [symbol] O{3,4} [symbol] 1
I{4,4} [symbol] O{4,4} [symbol] 1

In accordance with the current invention, all the head of line packets with accepted grants, from the 16 input queues, will be switched, in four switching times in nonblocking manner, from the input ports to the output ports via the interconnection network in the middle stage 130. In each switching time at most one packet is switched from each input port and at most one packet is switched into each output port. Each packet request with rate weight more than one is treated in such a way that there are as many separate requests as the rate weight, but with the same input queue to be switched from and the same output queue to be switched to. Now applicant makes an important observation that the problem of deterministic and nonblocking scheduling of the accepted packets from the 16 input queues to switch to the 16 output queues at output ports 191-194 in switch fabric 10 of FIG. 1A is related to the nonblocking scheduling of the three-stage clos network 14 shown in FIG. 1C.

Referring to FIG. 1C, an exemplary symmetrical three-stage Clos network 14 operated in time-space-time (TST) configuration of ten switches for satisfying communication requests between an input stage 110 and output stage 120 via a middle stage 130 is shown where input stage 110 consists of four, four by two switches IS1-IS4 and output stage 120 consists of four, two by four switches OS1-OS4, and middle stage 130 consists of two, four by four switches MS1-MS2. The number of inlet links to each of the switches in the input stage 110 and outlet links to each of the switches in the output stage 120 is denoted by n, and the number of switches in the input stage 110 and output stage 120 is denoted by r. Each of the two middle switches MS1-MS2 are connected to each of the r input switches through r links (for example the links FL1-FL4 connected to the middle switch MS1 from each of the input switch IS1-IS4), and connected to each of the output switches through r second internal links (for example the links SL1-SL4 connected from the middle switch MS1 to each of the output switch OS1-OS4). The network has 16 inlet links namely I{1,1}-I{4,4} and 16 outlet links O{1,1}-O{4,4}. Just like in switch fabric 10 of FIG. 1A in the three-stage clos network 14 of FIG. 1C, all the 16 input links are also assigned to the 16 output links as shown in Table 1. The network 14 of FIG. 1C is operable in strictly non-blocking manner for unicast connection requests, when the number of switches in the middle stage 130 is equal to

$$\frac{2 \times n - 1}{n} ≅ 2$$

switches (See Charles Clos “A Study of Non-Blocking Switching Networks”, The Bell System Technical Journal, vol. XXXII, Jan. 1953, No. 1, pp. 406-424 that is incorporated by reference, as background to the invention).

In accordance with the current invention, in one embodiment with two four by four crossbar networks 131-132 in the middle stage 130, i.e., with a speedup of two, switch fabric 10 of FIG. 1A is operated in strictly nonblocking manner. The specific method used in implementing the strictly non-blocking and deterministic switching can be any of a number of different methods that will be apparent to a skilled person in view of the disclosure. One such scheduling method is the scheduling part of the arbitration and scheduling method 40 of FIG. 1B.

TABLE 5
Multirate Packet Assignment in FIG. 1A using the Method of FIG. 1B
corresponding to the Acceptances of TABLE 4
Packets Scheduled in Switching time
1 (Shown in FIG. 1D & FIG. 1H)
I{1,1} [symbol] O{1,1}
I{3,3} [symbol] O{3,3}
I{4,4} [symbol] O{4,4}
Packets Scheduled in Switching
time 2 (Shown in FIG. 1E)
I{1,1} [symbol] O{1,1}
I{3,2} [symbol] O{2,3}
I{4,3} [symbol] O{3,4}
Packets scheduled in Switching
time 3 (Shown in FIG. 1F)
I{1,4} [symbol] O{4,1}
I{2,3} [symbol] O{3,2}
I{3,1} [symbol] O{1,3}
I{4,2} [symbol] O{2,4}
Packets scheduled in Switching
time 4 (Shown in FIG. 1G)
I{1,4} [symbol] O{4,1}
I{3,2} [symbol] O{2,3}
I{4,1} [symbol] O{1,4}

Table 5 shows the schedule of the packets in each of the four switching times for the packet acceptances of Table 4, computed using the scheduling part of the arbitration and scheduling method 40 of FIG. 1B, in one embodiment FIG. 1D to FIG. 1H show the state of switch fabric 10 of FIG. 1A after each switching time. FIG. 1D shows the state of switch fabric 10 of FIG. 1A after the first switching time during which the packets A1, K1, and P1 are switched to the output queues. Packet A1 from input port 151 is switched via crossbar network 131 into the output queue 181 of output port 191. Packet K1 from input port 153 is switched via crossbar network 132 into the output queue 183 of output port 193. Packet P1 from input port 154 is switched via crossbar network 132 into the output queue 184 of output port 194. Clearly at most one packet from each input port is switched and each output port receives at most one packet in the first switching time.

FIG. 1E shows the state of switch fabric 10 of FIG. 1A after the second switching time during which the packets A2, J1, and O1 are switched to the output queues. Packet A2 from input port 151 is switched via crossbar network 131 into the output queue 181 of output port 191. Packet J1 from input port 153 is switched via crossbar network 132 into the output queue 183 of output port 192. Packet O1 from input port 154 is switched via crossbar network 132 into the output queue 184 of output port 193. Again at most one packet from each input port is switched and each output port receives at most one packet in the second switching time.

FIG. 1F shows the state of switch fabric 10 of FIG. 1A after the third switching time during which the packets D1, G1, I1, and N1 are switched to the output queues. Packet D1 from input port 151 is switched via crossbar network 131 into the output queue 181 of output port 194. Packet G1 from input port 152 is switched via crossbar network 131 into the output queue 182 of output port 193. Packet I1 from input port 153 is switched via crossbar network 132 into the output queue 183 of output port 191. Packet N1 from input port 154 is switched via crossbar network 132 into the output queue 184 of output port 192. Once again at most one packet from each input port is switched and each output port receives at most one packet in the third switching time.

FIG. 1G shows the state of switch fabric 10 of FIG. 1A after the fourth switching time during which the packets D2, J2, and M1 are switched to the output queues. Packet D2 from input port 151 is switched via crossbar network 132 into the output queue 181 of output port 194. Packet J2 from input port 153 is switched via crossbar network 131 into the output queue 183 of output port 192. Packet M1 from input port 154 is switched via crossbar network 132 into the output queue 184 of output port 191. Clearly at most one packet from each input port is switched and each output port receives at most one packet in the fourth switching time.

FIG. 1H shows the state of switch fabric 10 of FIG. 1A after the fifth switching time during which the packets A3, K2, and P2 are switched to the output queues just the same way as A1, K1 and P1 are switched in the first switching time. Packet A3 from input port 151 is switched via crossbar network 131 into the output queue 181 of output port 191. Packet K2 from input port 153 is switched via crossbar network 132 into the output queue 183 of output port 193. Packet P2 from input port 154 is switched via crossbar network 132 into the output queue 184 of output port 194. And so the arbitration and scheduling method 40 of FIG. 1B need not do the rescheduling after the schedule for the first four switching times is performed. And so the packets from any particular input queue to the destined output queue are switched along the same path and travel in the same order as they are received by the input port and hence never arises the issue of packet reordering.

Since in the four switching times the maximum of 16 packets are switched to the output ports, the switch is nonblocking and operated at 100% throughput, in accordance with the current invention. Since switch fabric 10 of FIG. 1A is operated so that each output port, at a switching time, receives at least one packet as long as there is at least a packet from any one of input queues destined to it, hereinafter the switch fabric is called “work-conserving system”. It is easy to observe that a switch fabric is directly work-conserving if it is nonblocking. In accordance with the current invention, switch fabric 10 of FIG. 1A is operated so that no packet at the head of line of each input queues is held for more than as many switching times equal to the number of input queues (four) at each input port, hereinafter the switch fabric is called “fair system”. Since virtual output queues are used head of line blocking is also eliminated.

In accordance with the current invention, using the arbitration and scheduling method 40 of FIG. 1B, switch fabric 10 of FIG. 1A is operated so that each output port, at a switching time, receives at most one packet even if it is possible to switch two packets in a switching time using the speedup of two in the interconnection network. And the speedup is strictly used only to operate interconnection network in nonblocking manner, and absolutely never to congest the output ports. Hence the arbitration and scheduling method 40 of FIG. 1B, to switch packets in switch fabric 10 of FIG. 1A is deterministic. Each inlet link 141-144 receives packets at the same rate as each outlet link 201-204 transmits, i.e., one packet in each switching time. Since only one packet is deterministically switched from each input port 151-154 in each switching time, and only one packet is switched into each output port 191-194, the packet fabric 10 of FIG. 1A never congests the output ports.

An important advantage of deterministic switching in accordance with the current invention is packets are switched out of the input ports at most at the peak rate. That also means packets are received at the output ports at most the peak rate. It means no traffic management is needed in the output ports and the packets are transmitted out of the output ports deterministically. And hence the traffic management is required only at the input ports in switch fabric 10 of FIG. 1A.

Another important characteristic of switch fabric 10 of FIG. 1A is all the packets belonging to a particular input queue are switched to the same output queue in the destined output port. Applicant notes three key benefits due to the output queues. 1) In a switching time, a byte or a certain number of bytes are switched from the input ports to the output ports. Alternatively switching time of the switch fabric is variable and hence is a flexible parameter during the design phase of switch fabric. 2) So even if the packets A1-P1 are of arbitrarily long and variable size, since each packet in an input queue is switched into the same output queue in the destined output port, the complete packet need not be switched in a switching time. Alternatively the second benefit of output queues is, longer packets need not be physically segmented in the input port and rearranged in the output port. The packets are logically switched to output queues segment by segment, (the size of the packet segment is determined by the switching time.) with out physically segmenting the packets; the packet segments in each packet are also switched through the same path from the input queue to the destined output queue. 3) The third benefit of the output queues is packets and packet segments are switched in the same order as they are received by the input ports and never arising the issue of packet reordering.

FIG. 1I shows a switch fabric 16 switching long packets. Table 1 shows an exemplary input queue to output queue assignment in switch fabric 16 of FIG. 1I, in exactly same way as in switch fabric 10 of FIG. 1A. Unicast packets in all the 16 input queues are assigned to the 16 output queues as shown in Table 1. Multirate unicast packets from any given input queue are always switched to the same designated output queue as shown in Table 1.

Table 2 shows an exemplary set of multirate unicast packet requests from input queues of the input ports in switch fabric 16 of FIG. 1I, just like in switch fabric 10 of FIG. 1A. Table 4 shows the packets scheduled to be switched after implementing the arbitration part of the arbitration and scheduling method 40 of FIG. 1B for the requests in Table 2. Multirate packet {A1-A4} in input queue I{1,1} is assigned to be switched to output queue O{1,1} with a rate weight of 2. There are no packets to be switched from input queues I{1,2} and I{1,3}. Multirate packet {D1-D4} in I{1,4} is assigned to be switched to output queue O{4,1} with a rate weight of 2. Similarly among the rest of 16 input queues, only the input queues that have multirate packets assigned an output queue are shown in Table 4. The rate weight of packets from each input queue 171-174 of all the input ports 151-154 is denoted by 211-214 as shown in FIG. 1I.

Each of these long packets consists of 4 equal size packet segments. For example packet {A1-A4} consists of four packet segments namely A1, A2, A3, and A4. If packet size is not a perfect multiple of four of the size of the packet segment, the fourth packet may be shorter in size. However none of the four packet segments are longer than the maximum packet segment size. Packet segment size is determined by the switching time; i.e., in each switching time only one packet segment is switched from any input port to any output port. Excepting for longer packet sizes the diagram of switch fabric 16 of FIG. 1I is same as the diagram of switch fabric 10 of FIG. 1A.

The arbitration and scheduling method 40 of FIG. 1B also operates switch fabric 16 of FIG. 1I in nonblocking and deterministic manner with a speedup of two in the middle stage. Just the same way it is performed in the case of switch fabric 10 of FIG. 1A, the arbitration part of method 40 of FIG. 1B comprises three steps: namely the generation of requests by the input ports, the issuance of grants by the output ports and the acceptance of the grants by the input ports. Table 2 shows the arbitration requests generated by the input ports, Table 3 shows the arbitration requests received by the output ports, Table 4 shows the arbitration grants issued by the output ports and also the acceptances generated by the input ports, and Table 5 shows the schedule computed, in one embodiment, by the scheduling part of arbitration and scheduling method 40 of FIG. 1B.

FIG. 1J to FIG. 1M show the state of switch fabric 16 of FIG. 1I after each fabric switching cycle. FIG. 1J shows the state of switch fabric 16 of FIG. 1I after the first fabric switching cycle during which all the head of line packet segments in the accepted packet requests are switched to the output queues, according to the rate weight. These packet segments are switched to the output queues in exactly the same manner, using the arbitration and scheduling method 40 of FIG. 1B, as the accepted packet requests are switched to the output queues in switch fabric 10 of FIG. 1A as shown in FIGS. 1D-1G. FIG. 1K shows the state of switch fabric 16 of FIG. 1I after the second fabric switching cycle during which all the next set of head of line packet segments are switched to the output queues. FIG. 1L shows the state of switch fabric 16 of FIG. 1I after the third fabric switching cycle during which all the head of line packet segments are switched to the output queues. FIG. 1M shows the state of switch fabric 16 of FIG. 1I after the fourth fabric switching cycle during which all the head of line packet segments are switched to the output queues.

In each of the first, second, third, and fourth fabric switching cycles, the packet segments are switched to the output queues in exactly the same manner as the packets are switched to the output queues in switch fabric 10 of FIG. 1A as shown in the FIGS. 1D-1G. Clearly all the packet segments are switched in the same order, as received by the respective input ports. Hence there is no issue of packet reordering. Packets are also switched at 100% throughput, work conserving, and fair manner.

In FIGS. 1J-1M packets are logically segmented and switched to the output ports. In one embodiment, a tag bit ‘1’ is also padded in a particular designated bit position of each packet segment to denote that the packet segments are the first packet segments with in the respective packets. By reading the tag bit of ‘1’, the output ports recognize that the packet segments A1-P1 of the accepted packets are the first packet segments in a new packet. Similarly each packet segment is padded with the tag bit of ‘1’ in the designated bit position except the last packet segment which will be padded with ‘0’. (For example, in packets segments in switch fabric 16 of FIG. 1I, packet segments A1-P1, A2-P2 and A3-P3 are padded with tag bit of ‘1’ where as the packet segments A4-P4 are padded with the tag bit of ‘0’). When the tag bit is detected as ‘0’ the output port next expects a packet segment of a new packet or a new packet. If there is only one packet segment in a packet it will be denoted by a tag bit of ‘0’ by the input port. The output port if it receives two consecutive packet segments with the designated tag bit of ‘0’, it determines that the second packet segment is the only packet segment of a new packet.

In switch fabric 16 of FIG. 1I the packets are four segments long. However in general packets can be arbitrarily long. In addition different packets in the same queue can be of different size. In both the cases the arbitration and scheduling method 40 of FIG. 1B operates switch fabric in nonblocking manner, and the packets are switched at 100% throughput, work conserving, and fair manner. Also there is no need to physically segment the packets in the input ports and reassemble in the output ports. The switching time of the switch fabric is also a flexible design parameter so that it is set to switch packets byte by byte or a few bytes by few bytes in each switching time.

FIG. 1B shows a high-level flowchart of an arbitration and scheduling method 40, in one embodiment, executed by the scheduler of FIG. 1A. According to this embodiment, at most r requests with rate weight, will be generated from each input port in act 41. If the rate weight of packets from one or more input queues is more than one, the number of requests generated will be less than r However the sum of the rate weights of all the generated requests from each input port is at most r. Each input queue makes a request to a different output port. It must be observed that multirate packets do not arise input port contention; however backlog of packets in the previous switching cycles due to output port oversubscription may require input port contention resolution. An arbitrary policy (just the same way the output port contention is resolved as discussed below) may be used to resolve the input port contention in act 41.

In act 42, each output port will issue at most r grants, each request corresponding to an associated output queue. An output port grants requests such that the sum of the rate weights of all the granted requests is at most r. However an output port may receive requests, whose sum of rate weights is more than r. In that case the output port is oversubscribed and arise output port contention. An arbitration policy is used to select the grants such that the sum of the rate weights is at most r. In one embodiment it may be based on a priority scheme. However the type of selection policy used to avoid oversubscription is irrelevant to the current invention. In act 43, each input port accepts all the issued grants since the sum of the rate weights of all the issued grants to an input port will not be more than r.

In act 44, all the at most r² requests will be scheduled without rearranging the paths of previously scheduled packets. In one embodiment each request with rate weight more than one is considered as that many separate requests with rate weight of one having the same output queue of the destined output port. In accordance with the current invention, all the r² requests will be scheduled in strictly nonblocking manner with a speedup of at least two in the middle stage 130. It should be noted that the arbitration of generation of requests, issuance of grants, and generating acceptances is performed in only one iteration. After act 44 the control returns to act 45. In act 45 it will be checked if there are new and different requests at the input ports. If the answer is “NO”, the control returns to act 45. If there are new requests but they are not different such that request have same input queue to output queue requests, the same schedule is used to switch the next at most r² requests. When there are new and different requests from the input ports the control transfers from act 45 to act 41. And acts 41-45 are executed in a loop.

The network 14 of FIG. 1C can also be operated in rearrangeably non-blocking manner for unicast connection requests, when the number of switches in the middle stage 130 is equal to

$$\frac{n}{n} = 1$$

switch. Similarly according to the current invention, in another embodiment having multirate unicast packets in input queues using only one four by four crossbar network 131 in the middle stage 130, i.e., with a speedup of at least one, switch fabric 18 of FIG. 1N is operated in rearrangeably nonblocking manner.

In strictly nonblocking network, as the packets at the head of line of all the input queues are scheduled at a time, it is always possible to schedule a path for a packet from an input queue to the destined output queue through the network without disturbing the paths of prior scheduled packets, and if more than one such path is available, any path can be selected without being concerned about the scheduling of the rest of packets. In a rearrangeably nonblocking network, as the packets at the head of line of all the input queues are scheduled at a time, the scheduling of a path for a packet from an input queue to the destined output queue is guaranteed to be satisfied as a result of the scheduler's ability to rearrange, if necessary by rearranging, the paths of prior scheduled packets. Switch fabric 18 of FIG. 1N is operated in rearrangeably nonblocking manner where as switch fabric 10 of FIG. 1A is operated in strictly nonblocking manner, in accordance with the current invention.

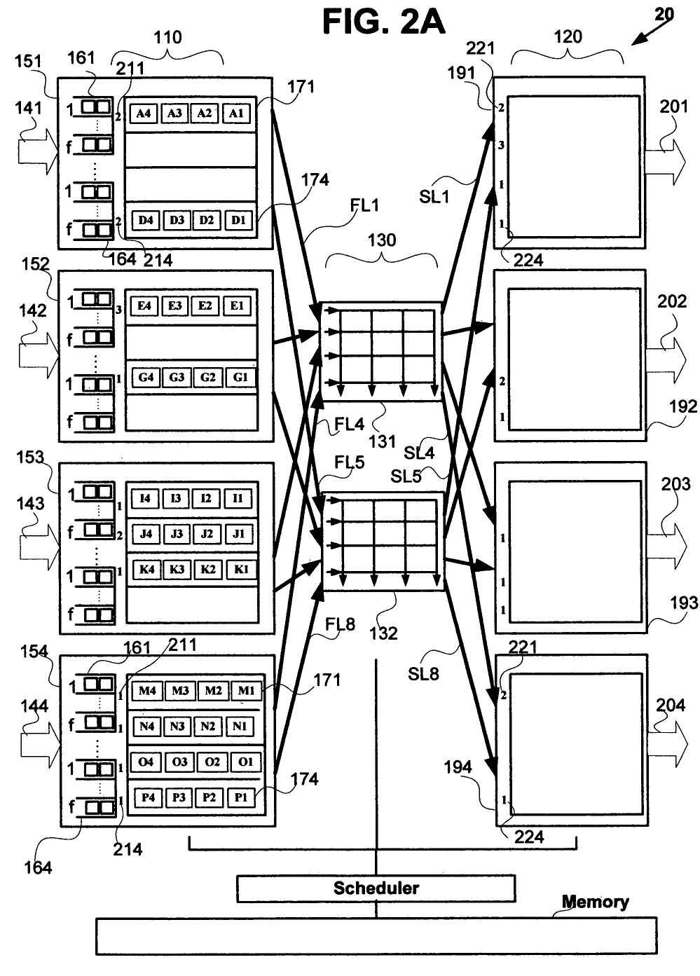

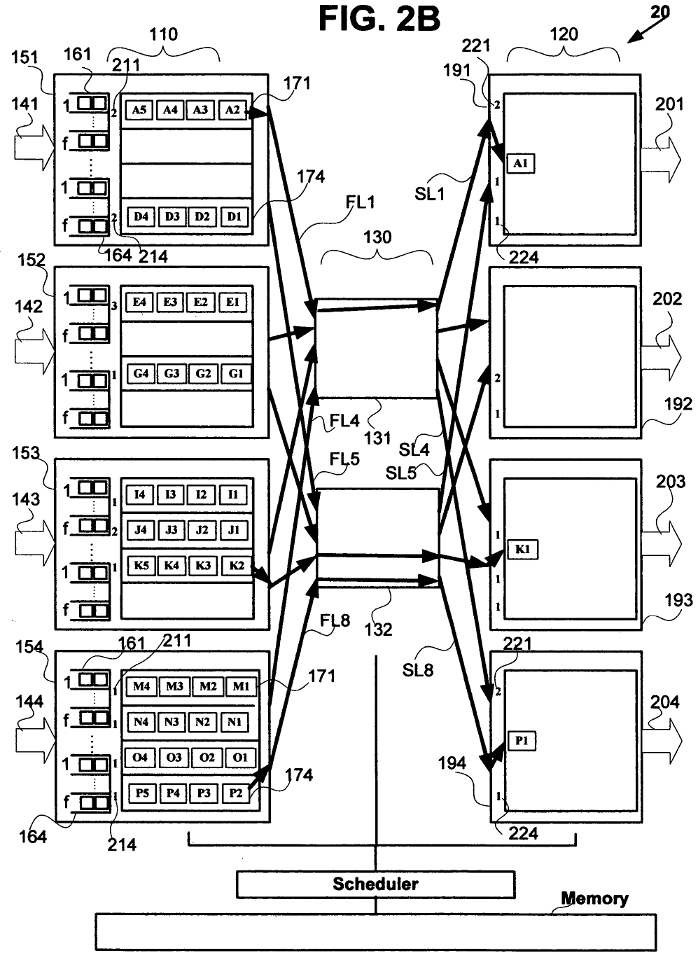

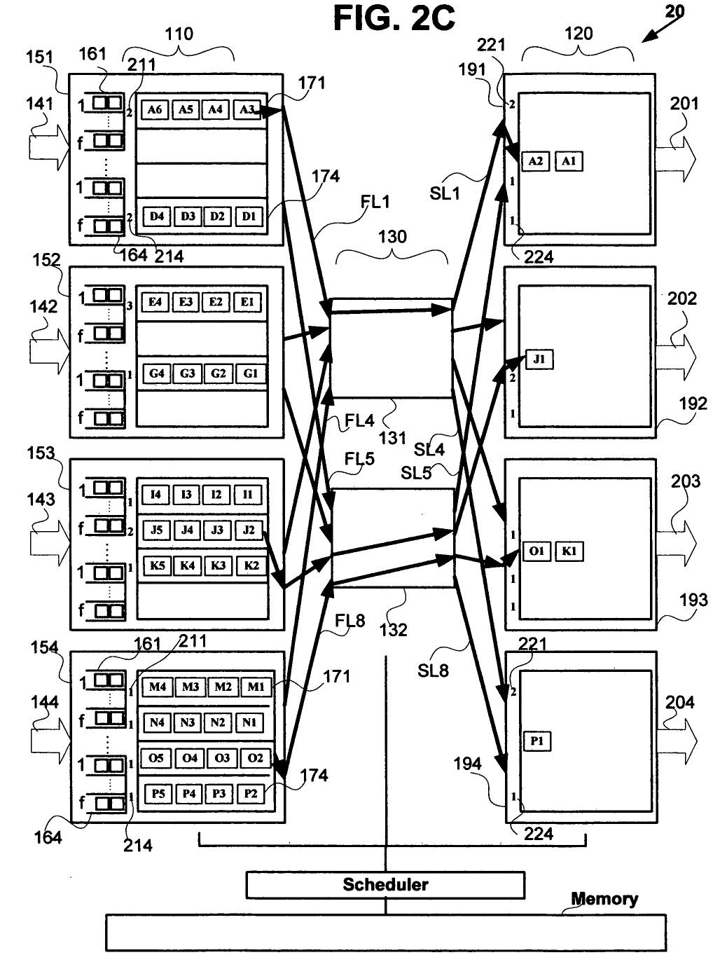

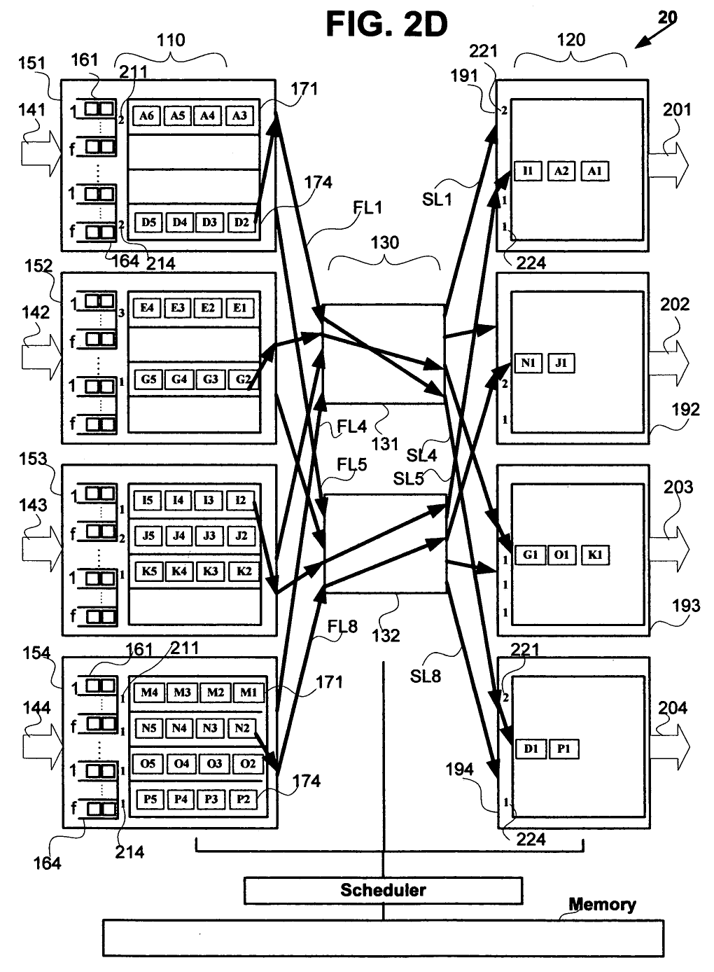

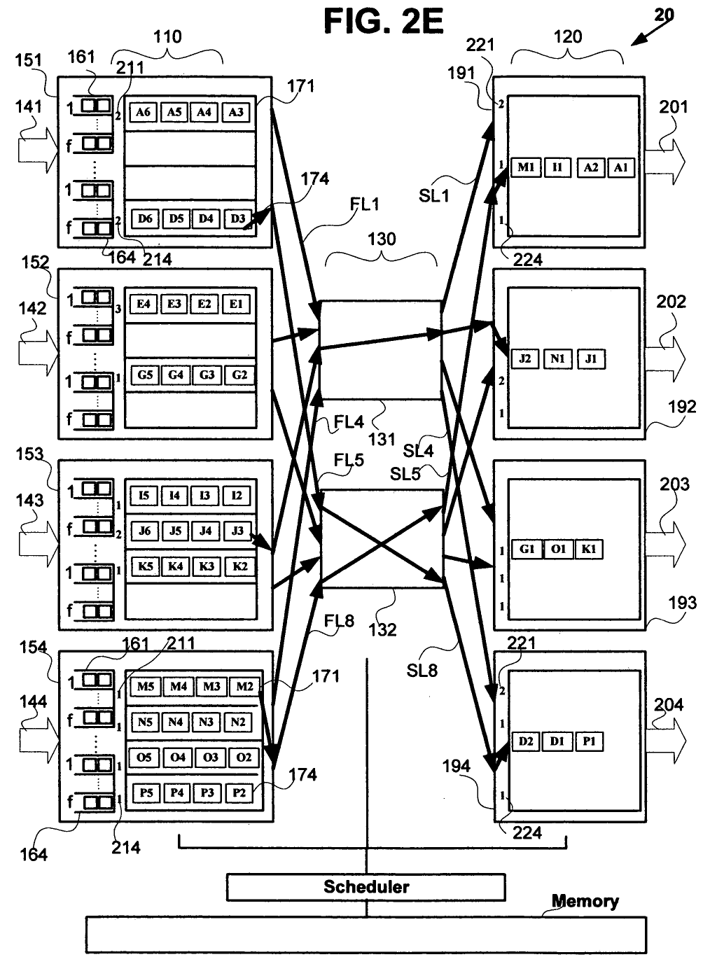

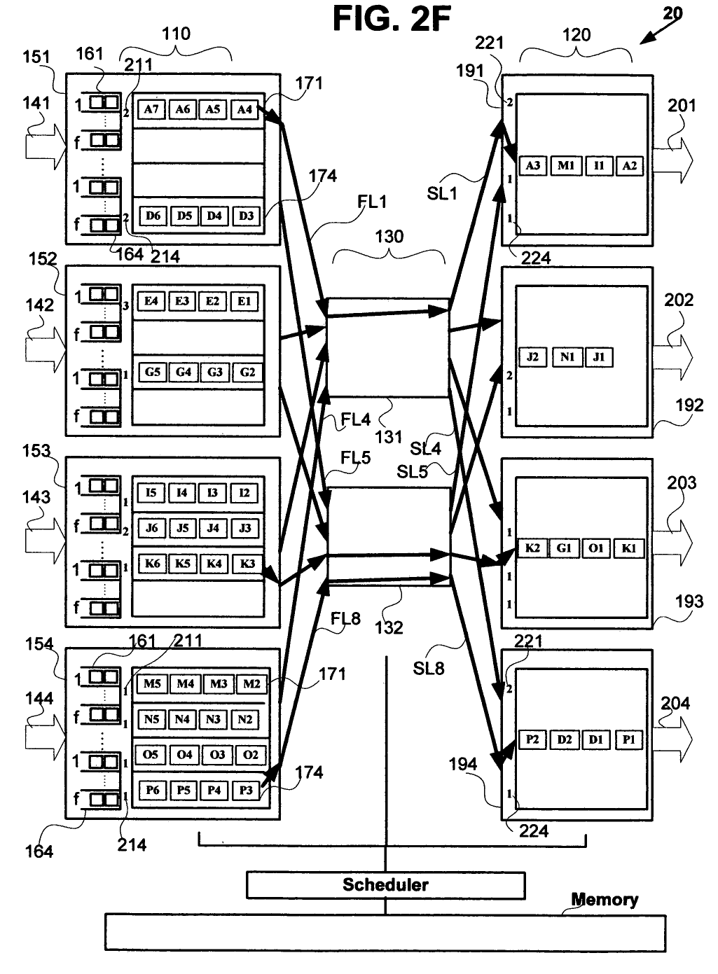

Referring to FIG. 2A a switch fabric 20 does not have output queues otherwise the diagram of switch fabric 20 of FIG. 2A is exactly same as the diagram of switch fabric 10 of FIG. 1A. In accordance with the current invention, switch fabric 20 is operated in strictly nonblocking and deterministic manner in the same way in every aspect that is disclosed about switch fabric 10 of FIG. 1A, excepting that it requires SAR in the input and output ports. Packets need to be segmented in the input ports as determined by the switching time and switched to the output ports need to be reassembled separately. However the arbitration and scheduling method 40 of FIG. 1B is also used to switch packets in switch fabric 20 of FIG. 2A. Here also the scheduling is performed on all the accepted packet requests at the same time, and assuming that virtually there are 16 output queues at the output ports as in the case of switch fabric 10 of FIG. 1A, and at most 16 packets, according to the rate weights, will be switched in four switching times. During the switching times, however the packets are switched into the destined output ports unlike the output queues in switch fabric 10 of FIG. 1A. FIGS. 2B-2F show the state of switch fabric 20 of FIG. 2A after each switching time in a fabric switching cycle, by scheduling the packet requests shown in Table 2. Using the arbitration and scheduling method of FIG. 1B and following the same steps described as in switch fabric 10 of FIG. 1A, the packets scheduled in each switching time are shown in Table 5.

FIG. 2B shows the state of switch fabric 20 of FIG. 2A after the first switching time during which the packets A1, K1, and P1 are switched to the output queues. Packet A1 from input port 151 is switched via crossbar network 131 into the output port 191. Packet K1 from input port 153 is switched via crossbar network 132 into the output port 193. Packet P1 from input port 154 is switched via crossbar network 132 into the output port 194. Clearly only one packet from each input port is switched and each output port receives only one packet in the first switching time.

FIG. 2C shows the state of switch fabric 20 of FIG. 2A after the second switching time during which the packets A2, J1, and O1 are switched to the output queues. Packet A2 from input port 151 is switched via crossbar network 131 into the output port 191. Packet J1 from input port 153 is switched via crossbar network 132 into the output port 192. Packet O1 from input port 154 is switched via crossbar network 132 into the output port 193. Again only one packet from each input port is switched and each output port receives only one packet in the second switching time.

FIG. 2D shows the state of switch fabric 20 of FIG. 2A after the third switching time during which the packets D1, G1, I1, and N1 are switched to the output queues. Packet D1 from input port 151 is switched via crossbar network 131 into the output port 194. Packet G1 from input port 152 is switched via crossbar network 131 into the output port 193. Packet I1 from input port 153 is switched via crossbar network 132 into the output port 191. Packet N1 from input port 154 is switched via crossbar network 132 into the output port 192. Once again only one packet from each input port is switched and each output port receives only one packet in the third switching time.

FIG. 2E shows the state of switch fabric 20 of FIG. 2A after the fourth switching time during which the packets D2, J2, and M1 are switched to the output queues. Packet D2 from input port 151 is switched via crossbar network 132 into the output port 194. Packet J2 from input port 153 is switched via crossbar network 131 into the output port 192. Packet M1 from input port 154 is switched via crossbar network 132 into the output port 191. Clearly only one packet from each input port is switched and each output port receives only one packet in the fourth switching time.

FIG. 2F shows the state of switch fabric 20 of FIG. 2A after the fifth switching time during which the packets A3, K2, and P2 are switched to the output queues just the same way as A1, K1 and P1 are switched in the first switching time. Packet A3 from input port 151 is switched via crossbar network 131 into the output port 191. Packet K2 from input port 153 is switched via crossbar network 132 into the output port 193. Packet P2 from input port 154 is switched via crossbar network 132 into the output port 194.

The arbitration and scheduling method 40 of FIG. 1B operates switch fabric 20 of FIG. 2A also in strictly nonblocking manner, and the packets are switched at 100% throughput, work conserving, and fair manner. The switching time of the switch fabric is also a flexible design parameter so that it can be set to switch packets byte by byte or a few bytes by few bytes in each switching time. However switch fabric 20 requires SAR, meaning that the packets need to be physically segmented in the input ports and reassembled in the output ports. Nevertheless in switch fabric 20 the packets and packet segments are switched through to the output ports in the same order as received by the input ports. In fact, excepting for the SAR, the arbitration and scheduling method 40 of FIG. 1B operates switch fabric 20 in every aspect the same way as described about switch fabric 10 of FIG. 1A.

Speedup of two in the middle stage for nonblocking operation of the switch fabric is realized in two ways: 1) parallelism and 2) doubling the switching rate. Parallelism is realized by using two interconnection networks in parallel in the middle stage, for example as shown in switch fabric 10 of FIG. 1A. The doubling of switching rate is realized by operating a single interconnection network, the first and second internal links at double clock rate, for each clock in the input and output ports. In the first clock the single interconnection network is operated for switching as the first interconnection network of an equivalent switch fabric implemented with two parallel interconnection networks, for example as the interconnection network 131 in switch fabric 10 of FIG. 1A. Similarly in the second clock the single interconnection network is operated as the second interconnection network, for example as the interconnection network 132 in switch fabric 10 of FIG. 1A. And so double rate in the clock speed of the interconnection network, and in the first and second internal links is required in this implementation. The arbitration and scheduling method 40 of FIG. 1B operates both the switch fabrics, implementing the speedup by either parallelism or by double rate, in nonblocking and deterministic manner in every aspect as described in the current invention.

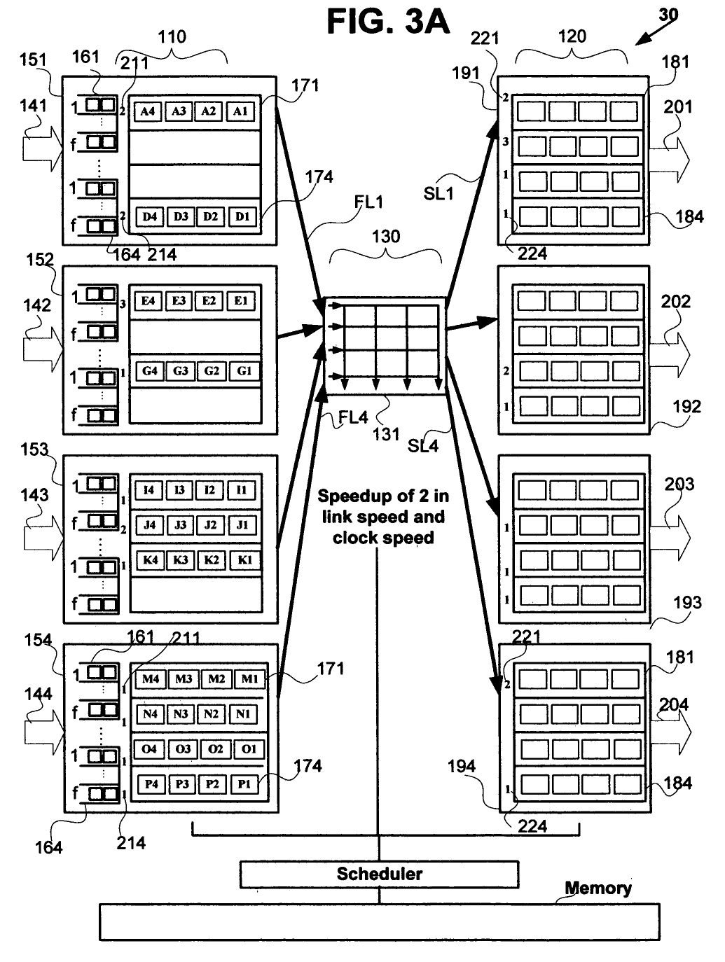

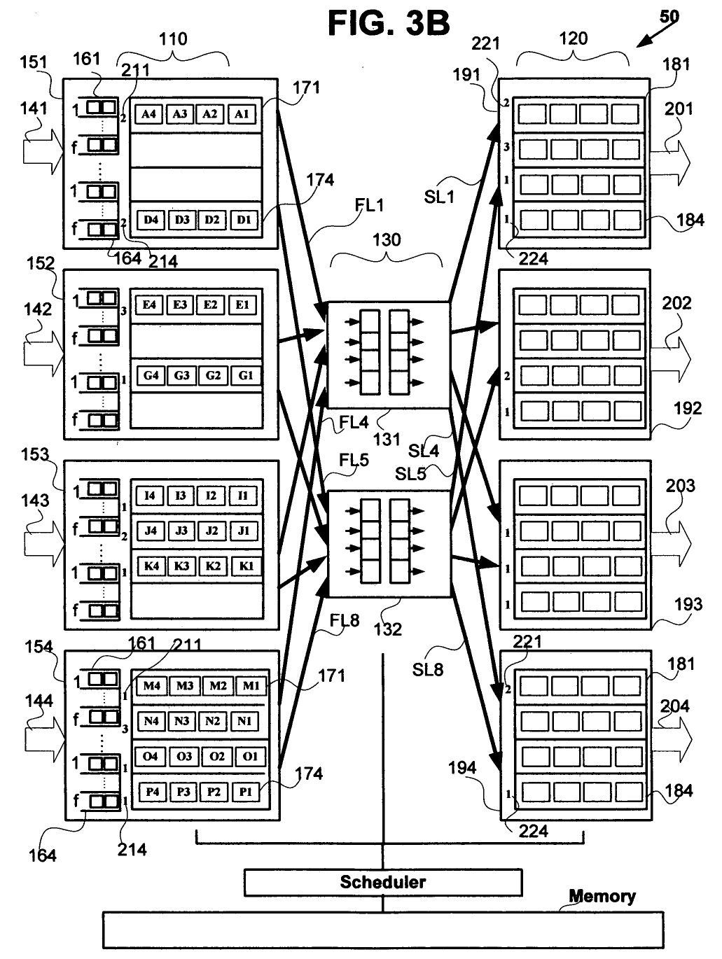

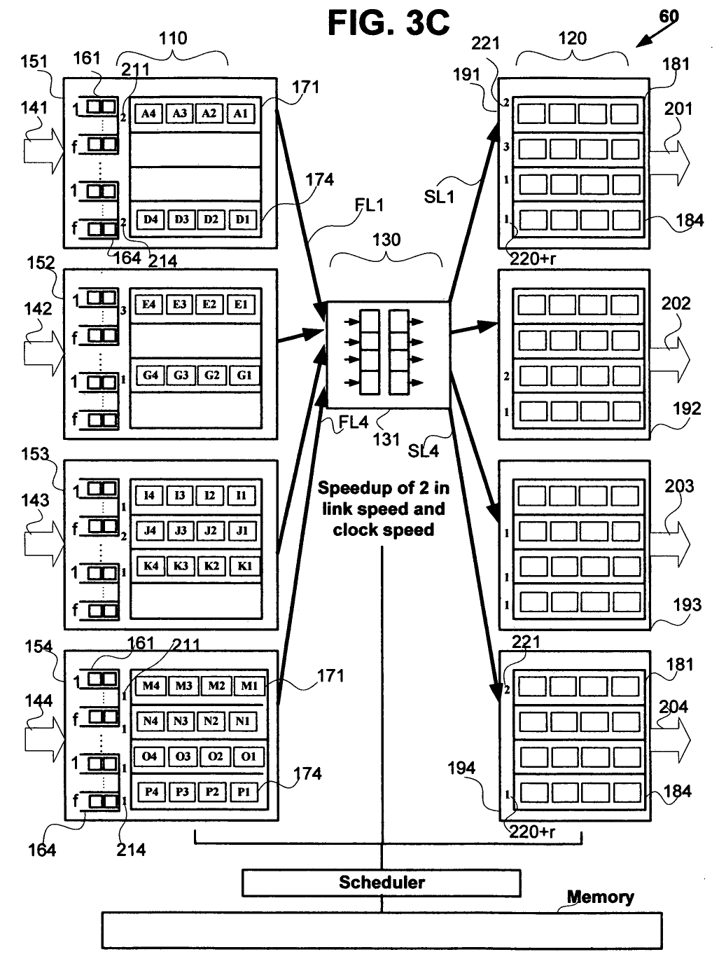

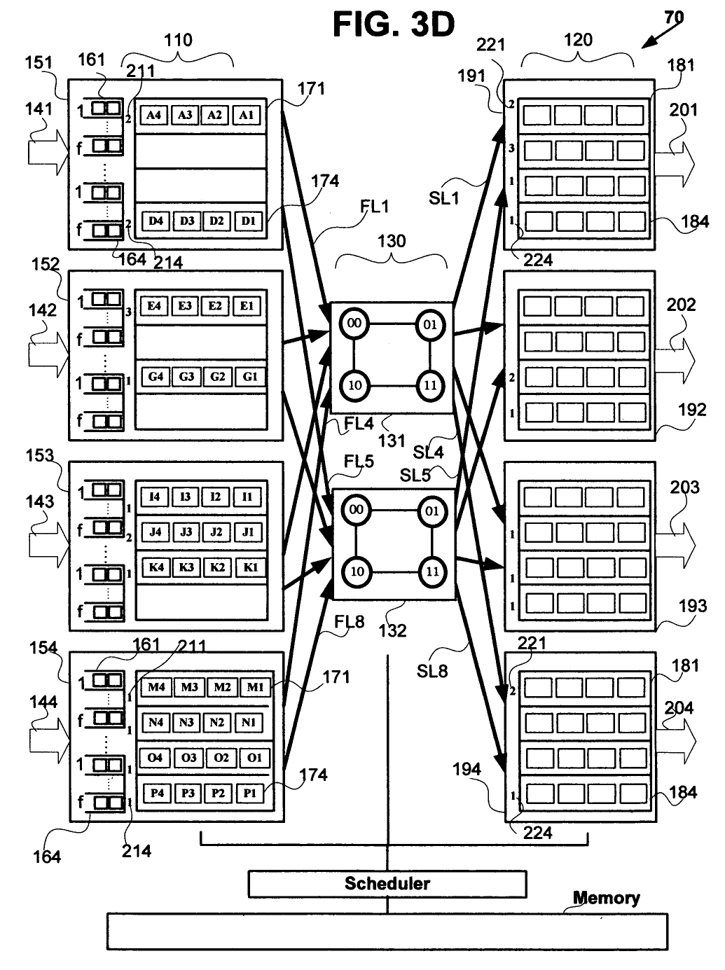

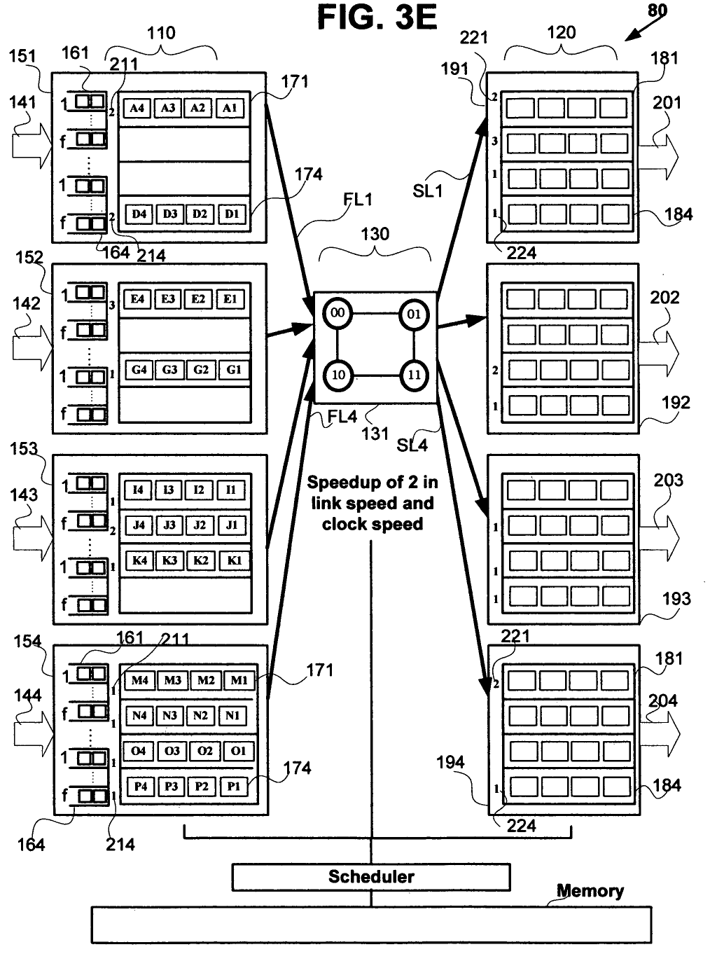

Referring to FIG. 3A shows the diagram of a switch fabric 30 which is the same as the diagram of switch fabric 10 of FIG. 1A excepting that speedup of two is provided with a speedup of two in the clock speed in only one crossbar interconnection network in the middle stage 130 and a speedup of two in the first and second internal links. In another embodiment of the network in FIG. 1A each of the interconnection networks in the middle stage are shared memory networks. FIG. 3B shows a switch fabric 50, which is the same as switch fabric 10 of FIG. 1A, excepting that speedup of two is provided with two shared memory interconnection networks in the middle stage 130. FIG. 3C shows a switch fabric 60 which is the same as switch fabric 30 of FIG. 3A excepting that speedup of two is provided with a speedup of two in the clock speed in only one shared memory interconnection network in the middle stage 130 and a speedup of two in the first and second internal links.

Similarly FIG. 3D shows a switch fabric 70, which is the same as switch fabric 10 of FIG. 1A, excepting that speedup of two is provided with two hypercube interconnection networks in the middle stage 130. FIG. 3E shows a switch fabric 60 which is exactly the same as switch fabric 30 of FIG. 3A excepting that speedup of two is provided with a speedup of two in the clock speed in only one hypercube based interconnection network in the middle stage 130 and a speedup of two in the first and second internal links.

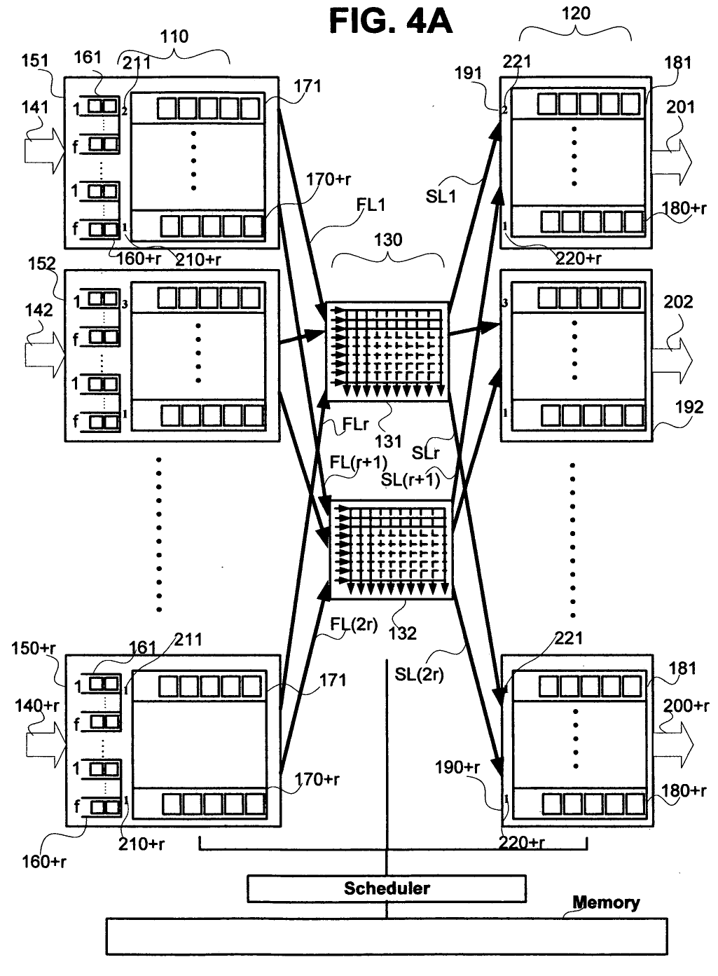

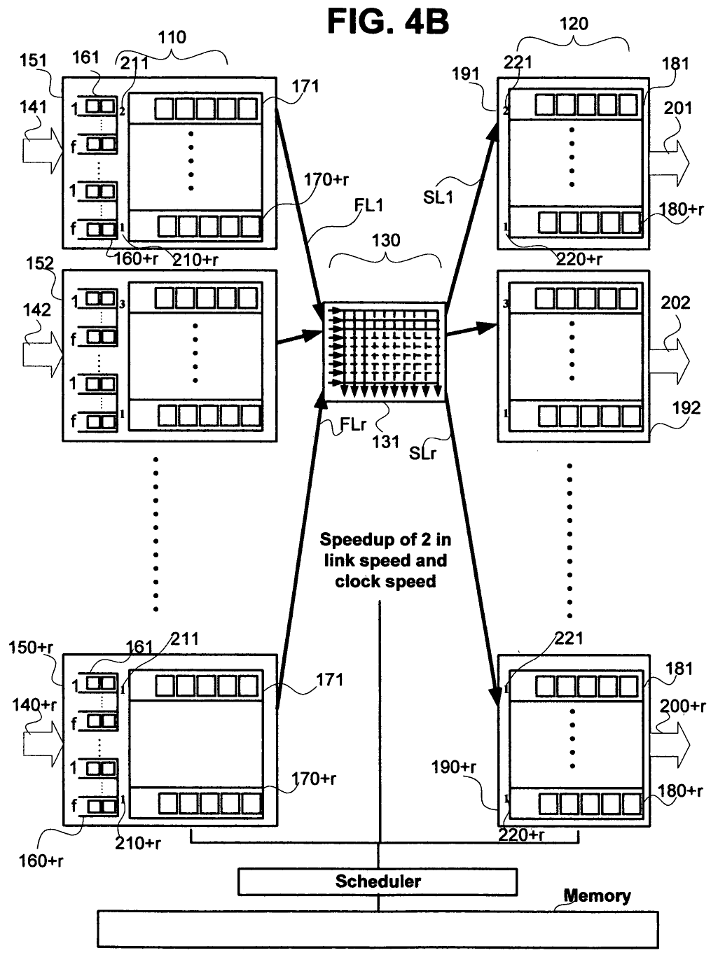

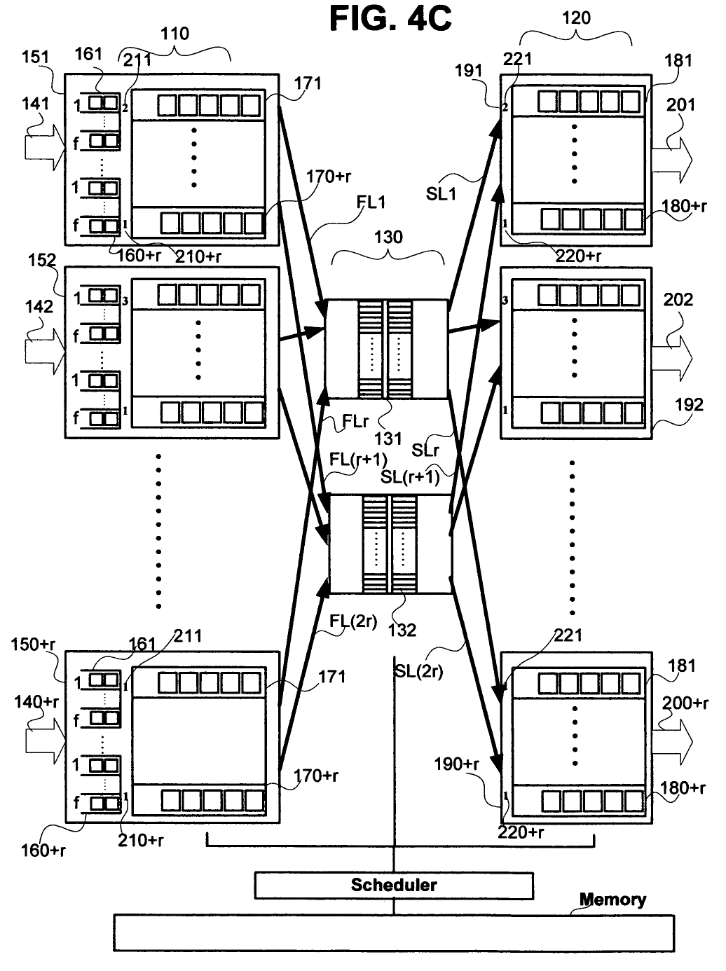

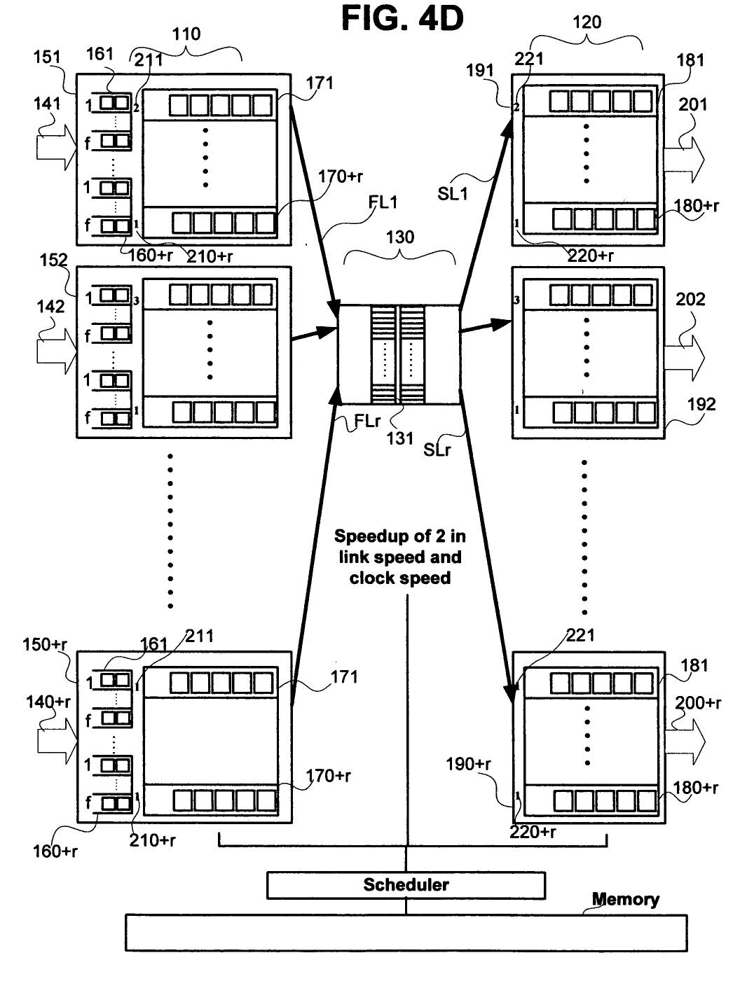

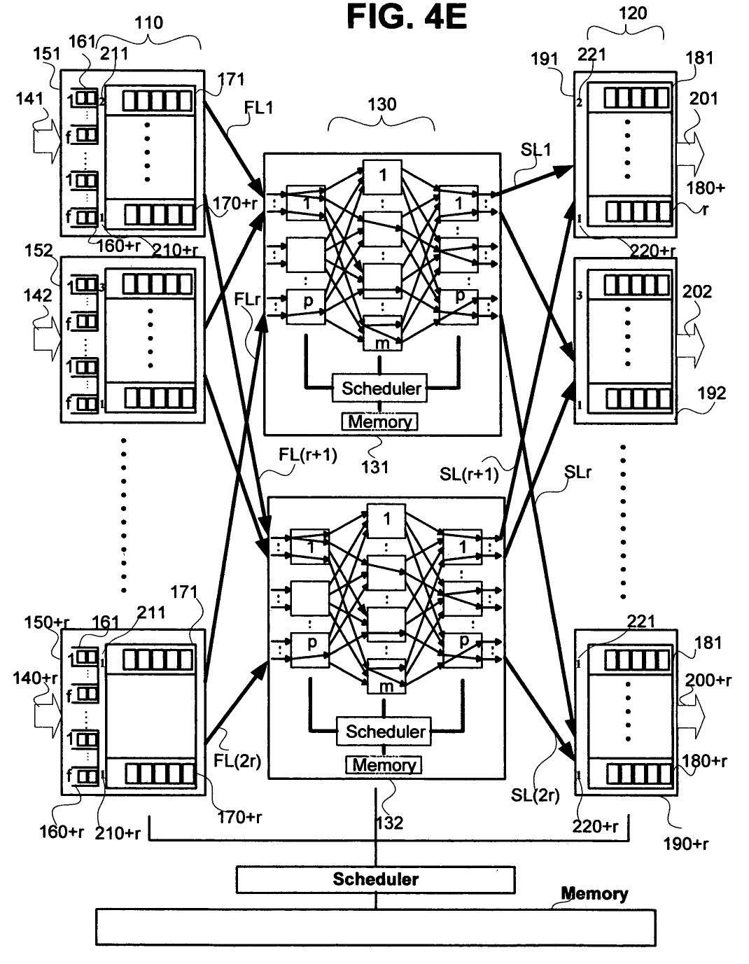

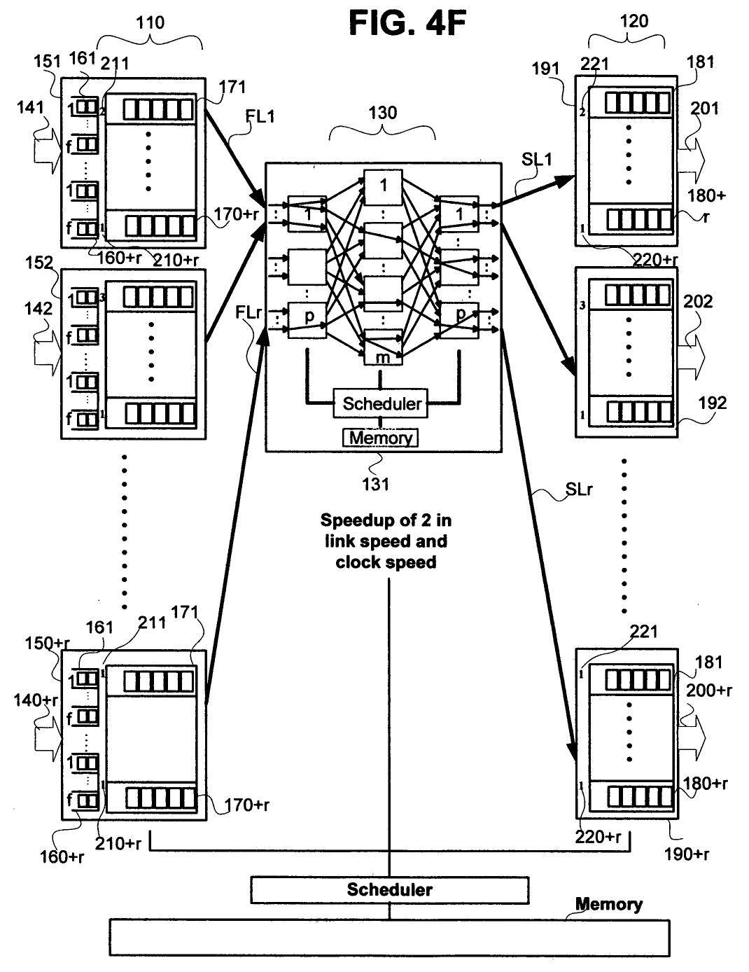

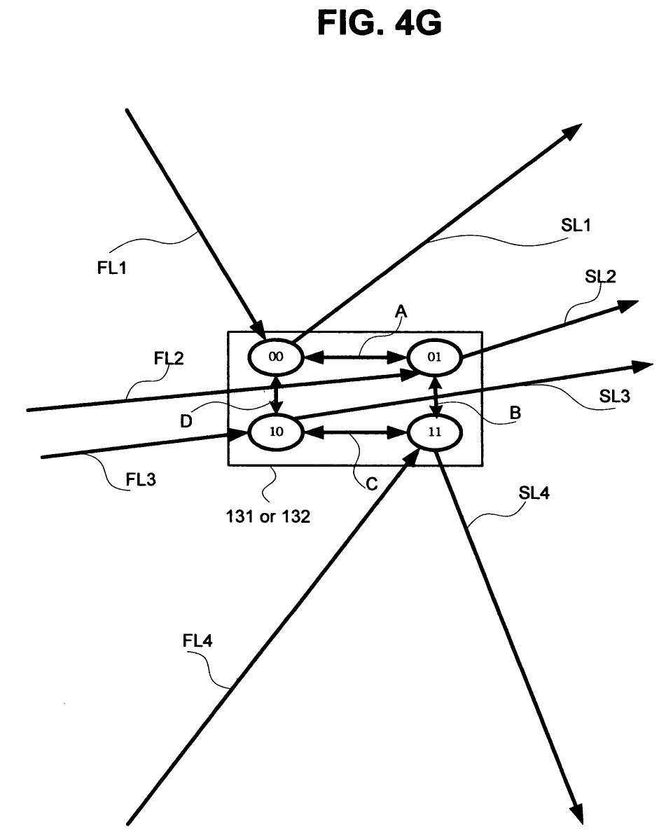

In switch fabrics 10 of FIG. 1A, 16 of FIG. 1I, 18 of FIG. 1N, 20 of FIG. 2A, 30 of FIG. 3A, 50 of FIG. 3B, 60 of FIG. 3C, 70 of FIG. 3D, and 80 of FIG. 3E the number of input ports 110 and output ports 120 is denoted in general with the variable r for each stage. The speedup in the middle stage is denoted by s. The speedup in the middle stage is realized by either parallelism, i.e., with two interconnection networks (as shown in FIG. 4A, FIG. 4C and FIG. 4E), or with double switching rate in one interconnection network (as shown in FIG. 4B, FIG. 4D and FIG. 4F). The size of each input port 151-{150+r} is denoted in general with the notation r*s (means each input port has r input queues and is connected to s number of interconnection networks with s first internal links) and of each output switch 191-{190+r} is denoted in general with the notation s*r (means each output port has r output queues and is connected to s number of interconnection networks with s second internal links). Likewise, the size of each interconnection network in the middle stage 130 is denoted as r*r. An interconnection network as described herein may be either a crossbar network, shared memory network, or a network of subnetworks each of which in turn may be a crossbar or shared memory network, or a three-stage clos network, or a hypercube, or any internally nonblocking interconnection network or network of networks. A three-stage switch fabric is represented with the notation of V(s,r).

Although it is not necessary that there be the same number of input queues 171-{170+r} as there are output queues 181-{180+r}, in a symmetrical network they are the same. Each of the s middle stage interconnection networks 131-132 are connected to each of the r input ports through r first internal links, and connected to each of the output ports through r second internal links. Each of the first internal links FL1-FLr and second internal links SL1-SLr are either available for use by a new packet or not available if already taken by another packet.

Switch fabric 10 of FIG. 1A is an example of general symmetrical switch fabric of FIG. 4A, which provides the speedup of two by using two crossbar interconnection networks in the middle stage 130. Referring to FIG. 4B shows the general symmetrical switch fabric which is the same as the switch fabric of FIG. 4A excepting that speedup of two is provided with a speedup of two in the clock speed in only one crossbar interconnection network in the middle stage 130 and a speedup of two in the first and second internal links.

FIG. 4C shows the general symmetrical switch fabric, which provides the speedup of two by using two shared memory interconnection networks in the middle stage 130. FIG. 4D shows the general symmetrical switch fabric, which provides the speedup of two by using a speedup of two in the clock speed in only one shared memory interconnection network in the middle stage 130 and a speedup of two in the first and second internal links.

FIG. 4E shows the general symmetrical switch fabric, which provides the speedup of two by using two, three-stage clos interconnection networks in the middle stage 130. FIG. 4F shows the general symmetrical switch fabric, which provides the speedup of two by using a speedup of two in the clock speed in only one three-stage clos interconnection network in the middle stage 130 and a speedup of two in the first and second internal links.

In general the interconnection network in the middle stage 130 may be any interconnection network: a hypercube, or a batcher-banyan interconnection network, or any internally nonblocking interconnection network or network of networks. In one embodiment interconnection networks 131 and 132 may be two of different network types. For example, the interconnection network 131 may be a crossbar network and interconnection network 132 may be a shared memory network. In accordance with the current invention, irrespective of the type of the interconnection network used in the middle stage, a speedup of at least two in the middle stage operates switch fabric in strictly nonblocking manner using the arbitration and scheduling method 40 of FIG. 1B. And a speedup of at least one in the middle stage operates the switch fabric in rearrangeably nonblocking manner.

It must be noted that speedup in the switch fabric is not related to internal speedup of an interconnection network. For example, crossbar network and shared memory networks are fully connected topologies, and they are internally nonblocking without any additional internal speedup. For example the interconnection networks 131-132 in either switch fabric 10 of FIG. 1A or switch fabric 50 of FIG. 3B which are crossbar network or shared memory networks, there is no speedup required in either the interconnection network 131-132 to be operable in nonblocking manner. However if the interconnection network 131-132 is a three-stage clos network, each three-stage clos network requires an internal speedup of two to be operable in strictly nonblocking manner. In a switch fabric where the middle stage interconnection networks 131-132 are three-stage clos networks, switch fabric speedup of two is provided in the form of two different three-stage clos networks like 131-132. In addition each three-stage clos network 131-132 in turn require additional speedup of two for them to be internally strictly nonblocking. Clearly, switch fabric speedup is different from internal speedup of the interconnection networks.

Similarly if the interconnection network in the middle stage 131 and 132 is a hypercube network, in one embodiment, an internal speedup of d is needed in a d-rank hypercube (comprising 2^{d} nodes) for it to be nonblocking network. In accordance with the current invention, the middle stage interconnection networks 131 or 132 may be any interconnection network that is internally nonblocking for the switch fabric to be operable in strictly nonblocking manner with a speedup of two in the middle stage using the arbitration and scheduling method 40 of FIG. 1B, and to be operable in rearrangeably nonblocking manner with a speedup of at least one in the middle stage.

Referring to FIG. 4G shows a detailed diagram of a four by four port (2-rank) hypercube based interconnection network in one embodiment of the middle stage interconnection network 131 or 132 in switch fabric 70 of FIG. 3D and switch fabric 80 of FIG. 3E. There are four nodes in the 4-node hypercube namely: 00, 01, 10, and 11. Node 00 is connected to node 01 by the bidirectional link A. Node 01 is connected to node 11 by the bidirectional link B. Node 11 is connected to node 10 by the bi-directional link C. Node 10 is connected to node 00 by the bi-directional link D. And each of the four nodes is connected to the input and output ports of the switch fabric. Node 00 is connected to the first internal link FL1 and the second internal link SL1. Node 01 is connected to the first internal link FL2 and the second internal link SL2. Node 10 is connected to the first internal link FL3 and the second internal link SL3. Node 11 is connected to the first internal link FL4 and the second internal link SL4. For the hypercube network 131 or 132 shown in FIG. 4G to be internally nonblocking, in one embodiment, it is needed to operate the links A, B, C, and D in both the directions at the same rate as the inlet links (or outlet links) of the switch fabric, or with a speedup of some factor depending on the scheduling scheme of the hypercube network. According to the current invention, it is required for the hypercube to operated in internally nonblocking manner, and for the switch fabric to be operable in strictly nonblocking manner with a speedup of at least two using the arbitration and scheduling method 40 of FIG. 1B, and to be operable in rearrangeably nonblocking manner with a speedup of at least one in the middle stage.

Although FIGS. 4A-4F show an equal number of first internal links and second internal links, as in the case of a symmetrical switch fabric, the current invention is now extended to non-symmetrical switch fabrics. In general, an (r₁*r₂) asymmetric switch fabric, for switching multirate unicast packets with rate weight, comprising r₁ input ports with each input port having r₂ input queues, r₂ output ports with each output port having r₁ output queues, and an interconnection network having a speedup of at least

$$s = \frac{{r}_{1} + {r}_{2} - 1}{MAX ( {r}_{1} , {r}_{2} )} ≅ 2$$

with s subnetworks, and each subnetwork comprising at least one first internal link connected to each input port for a total of at least r₁ first internal links, each subnetwork further comprising at least one second internal link connected to each output port for a total of at least r₂ second internal links is operated in strictly nonblocking manner in accordance with the invention by scheduling, corresponding to the rate weight, at most r₁ packets in each switching time to be switched in at most r₂ switching times when r₁≦r₂, in deterministic manner, and without the requirement of segmentation and reassembly of packets. In another embodiment, the switch fabric is operated in strictly nonblocking manner by scheduling corresponding to the rate weight, at most r₂ packets in each switching time to be switched in at most r₁ switching times when r₂≦r₁, in deterministic manner, and without the requirement of segmentation and reassembly of packets.

Such a general asymmetric switch fabric is denoted by V(s,r₁,r₂). In one embodiment, the system performs only one iteration for arbitration, and with mathematical minimum speedup in the interconnection network. The system is also operated at 100% throughput, work conserving, fair, and yet deterministically thereby never congesting the output ports. The arbitration and scheduling method 40 of FIG. 1B is also used to schedule packets in V(s,r₁,r₂) switch fabrics.

The arbitration and scheduling method 40 of FIG. 1B also operates the general V(s,r₁,r₂) switch fabric in nonblocking manner, and the packets are switched at 100% throughput, work conserving, and fair manner. The switching time of the switch fabric is also a flexible design parameter so that it can be set to switch packets byte by byte or a few bytes by few bytes in each switching time. Also there is no need of SAR just as it is described in the current invention. In the embodiments without output queues the packets need to be physically segmented in the input ports and reassembled in the output ports.

In one embodiment, the non-symmetrical switch fabric V(s,r₁,r₂), for switching multirate unicast packets with rate weight, is operated in rearrangeably nonblocking manner with a speedup of at least

$$s = \frac{MAX ( {r}_{1} , {r}_{2} )}{MAX ( {r}_{1} , {r}_{2} )} = 1$$

in the interconnection network, by scheduling corresponding to the rate weight, at most r₁ packets in each switching time to be switched in at most r₂ switching times when r₁≦r₂, in deterministic manner, and without the requirement of segmentation and reassembly of packets. In another embodiment, the non-symmetrical switch fabric V(s,r₁,r₂) is operated in rearrangeably nonblocking manner with a speedup of at least

$$s = \frac{MAX ( {r}_{1} , {r}_{2} )}{MAX ( {r}_{1} , {r}_{2} )} = 1$$

in the interconnection network, by scheduling corresponding to the rate weight, at most r₂ packets in each switching time to be switched in at most r₁ switching times when r₂≦r₁, in deterministic manner and without the requirement of segmentation and reassembly of packets.

Similarly in an asymmetric switch fabric V(s,r₁,r₂), for switching multirate unicast packets with rate weight, comprising r₁ input ports with each input port having r₂ input queues, r₂ output ports, and an interconnection network having a speedup of at

$$s = \frac{{r}_{1} + {r}_{2} - 1}{MAX ( {r}_{1} , {r}_{2} )} ≅ 2$$

with s subnetworks, and each subnetwork comprising at least one first internal link connected to each input port for a total of at least r₁ first internal links, each subnetwork further comprising at least one second internal link connected to each output port for a total of at least r₂ second internal links is operated in strictly nonblocking manner, in accordance with the invention, by scheduling corresponding to the rate weight, at most r₁ packets in each switching time to be switched in at most r₂ switching times, in deterministic manner, and requiring the segmentation and reassembly of packets. The arbitration and scheduling method 40 of FIG. 1B is also used to switch packets in V(s,r₁,r₂) switch fabrics without using output queues.

In an asymmetric switch fabric V(s,r₁,r₂), for switching multirate unicast packets with rate weight, comprising r₁ input ports with each input port having r₂ input queues, r₂ output ports, and an interconnection network having a speedup of at least

$$s = \frac{MAX ( {r}_{1} , {r}_{2} )}{MAX ( {r}_{1} , {r}_{2} )} = 1$$

with s subnetworks, and each subnetwork comprising at least one first internal link connected to each input port for a total of at least r₁ first internal links, each subnetwork further comprising at least one second internal link connected to each output port for a total of at least r₂ second internal links is operated in rearrangeably nonblocking manner in accordance with the invention by scheduling corresponding to the rate weight, at most r₁ packets in each switching time to be switched in at most r₂ switching times, in deterministic manner, and requiring the segmentation and reassembly of packets.

Applicant now notes that all the switch fabrics described in the current invention offer input port to output port rate and latency guarantees. End-to-end guaranteed bandwidth i.e., from any input port to any output port with the rate weight is provided based on the input queue to output queue assignment shown in Table 1. Guaranteed and constant latency is provided for packets from multiple input ports to any output port. Since each input port switches packets into its assigned output queue in the destined output port, a packet from one input port will not prevent another packet from a second input port switching into the same output port, and thus enforcing the latency guarantees of packets from all the input ports. The switching time of switch fabric determines the latency of the packets in each flow and also the latency of packet segments in each packet.

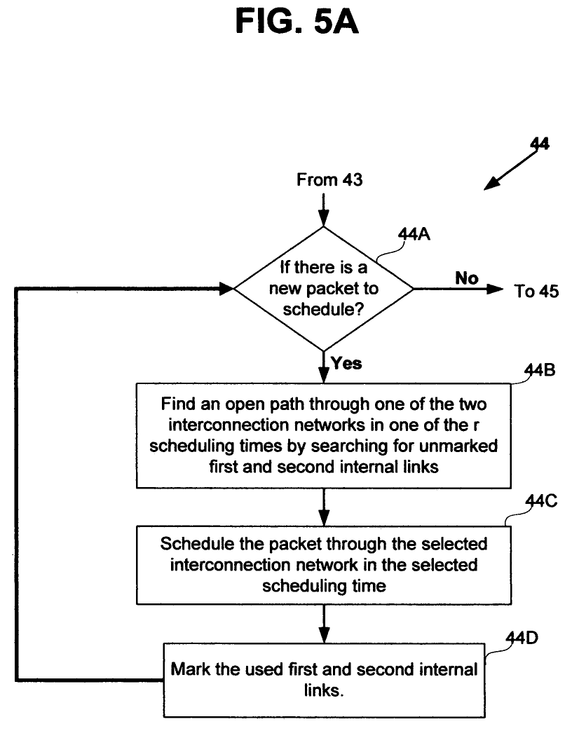

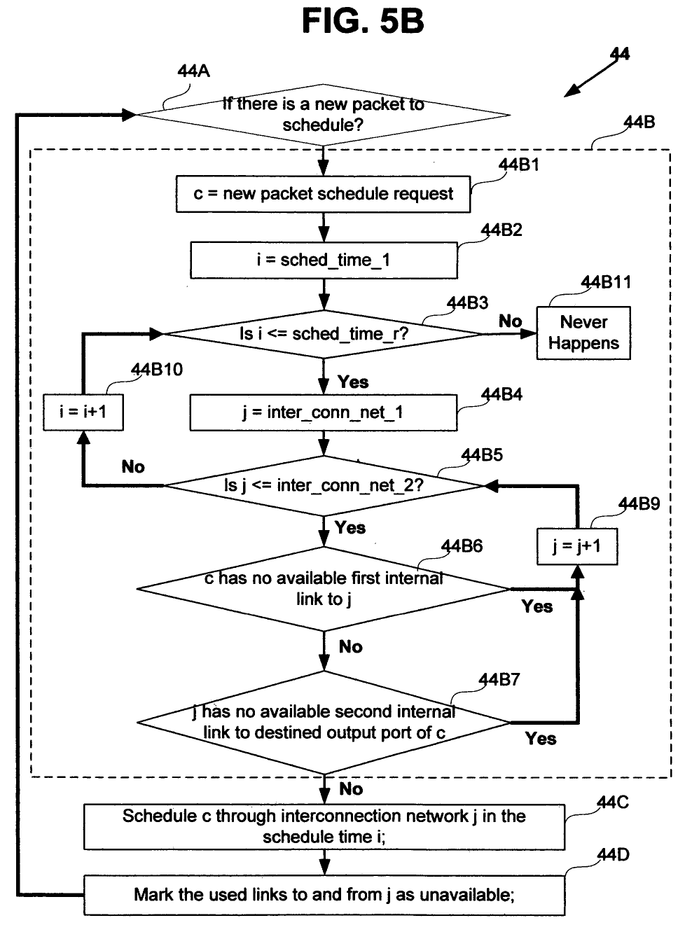

FIG. 5A shows an implementation of act 44 of the arbitration and scheduling method 40 of FIG. 1B. The scheduling of r² packets is performed in act 44. In act 44A, it is checked if there are more packets to schedule. If there are more packets to schedule, i.e., if all r² packets are not scheduled, the control transfers to act 44B. In act 44B an open path through one of the two interconnection networks in the middle stage is selected by searching through r scheduling times. The packet is scheduled through the selected path and selected scheduling time in act 44C. In 44D the selected first internal link and second internal link are marked as selected so that no other packet selects these links in the same scheduling time. Then control returns to act 44A and thus acts 44A, 44B, 44C, and 44D are executed in a loop to schedule each packet.

FIG. 5B shows a low-level flow chart of one variant of act 44 of FIG. 5A. Act 44A transfers the control act 44B if there is a new packet request to schedule. Act 44B1 assigns the new packet request to c. In act 44B2 sched_time_1 is assigned to index variable i. Then act 44B3 checks if i is less than or equal to schedule time r. If the answer is “YES” the control transfers to act 44B4. Another index variable j is set to interconnection network 1 in Act 44B4. Act 44B5 checks if j is either interconnection network 1 or 2. If the answer is “YES” the control transfers to act 44B6. Act 44B6 checks if packet request c has no available first internal link to interconnection network j in the scheduling time i. If the answer is “NO”, act 44B7 checks of interconnection network j in scheduling time i has no available second internal link to the destined output port of the packet request c. If the answer is “NO”, the control transfers to act 44C. In act 44C the packet request c is scheduled through the interconnection network j in the scheduling time i, and then in act 44D the first and second internal links, corresponding to the interconnection network j in the scheduling time i, are marked as used. Then the control goes to act 44A. If the answer results in “YES” in either act 44B6 or act 44B7 then the control transfers to act 44B9 where j is incremented by 1 and the control goes to act 44B5. If the answer results in “NO” in act 44B5, the control transfers to act 44B10. Act 44B10 increments i by 1, and the control transfers to act 44B3. Act 44B3 never results in “NO”, meaning that in the r scheduling times, the packet request c is guaranteed to be scheduled. Act 44B comprises two loops. The inner loop is comprised of acts 44B5, 44B6, 44B7, and 44B9. The outer loop is comprised of acts 44B3, 44B4, 44B5, 44B6, 44B7, 44B9, and 44B10. The act 44 is repeated for all the packet requests until all r² packet requests are scheduled.

The following method illustrates the psuedo code for one implementation of the scheduling method 44 of FIG. 5A to schedule r² packet requests in a strictly nonblocking manner by using the speedup of two in the middle stage 130 (with either two interconnection networks, or a speedup of two in clock speed and link speeds) in the switch fabrics in FIGS. 4A-4F.

Pseudo code of the scheduling method:

| | |
|---|---|
| Step 1: | for each packet request to schedule do { |
| Step 2: | c = packet schedule request; |
| Step 3: | for i = sched_time_1 to sched_time_r do { |
| Step 4: | for j = inter_conn_net_1 to inter_conn_net_2 do { |
| Step 5: | if (c has no available first internal link to j) continue; |
| Step 6: | elseif (j has no available second internal link to the |
| | destined output port of c) continue; |
| Step 7: | else { |
| | Schedule c through interconnection network j in |
| | the schedule time i; |
| | Mark the used links to and from interconnection |
| | network j as unavailable; |
| | } |
| | } |
| | } |
| | } |

Step 1 starts a loop to schedule each packet. Step 2 labels the current packet request as “c”. Step 3 starts a second loop and steps through all the r scheduling times. Step 4 starts a third loop and steps through the two interconnection networks. If the input port of packet request c has no available first internal link to the interconnection network j in the scheduling time i in Step 5, the control transfers to Step 4 to select the next interconnection network to be i. Step 6 checks if the destined output port of packet request c has no available second internal link from the interconnection network j in the scheduling time i, and if so the control transfers to Step 4 to select the next interconnection network to be i. In Step 7 packet request c is set up through interconnection network j in the scheduling time i. And the first and second internal links to the interconnection network j in the scheduling time i are marked as unavailable for future packet requests. These steps are repeated for all the two interconnection networks in all the r scheduling times until the available first and second internal links are found. In accordance with the current invention, one interconnection network in one of r scheduling times can always be found through which packet request c can be scheduled. It is easy to observe that the number of steps performed by the scheduling method is proportional to s*r, where s is the speedup equal to two and r is the number of scheduling times and hence the scheduling method is of time complexity O(s*r).

Table 6 shows how the steps 1-8 of the above pseudo code implement the flowchart of the method illustrated in FIG. 5B, in one particular implementation.

TABLE 6

| Steps of the pseudo code of the | |
|---|---|
| scheduling method | Acts of Flowchart of FIG. 5B |
| 1 | 44A |
| 2 | 44B1 |
| 3 | 44B2, 44B3, 44B10 |
| 4 | 44B4, 44B5, 44B9 |
| 5 | 44B6 |
| 6 | 44B7 |
| 7 | 44C, 44D |

In strictly nonblocking scheduling of the switch fabric, to schedule a multirate packet request from an input queue to an output queue, it is always possible to find a path through the interconnection network to satisfy the request without disturbing the paths of already scheduled packets, and if more than one such path is available, any of them can be selected without being concerned about the scheduling of the rest of the packet requests. In strictly nonblocking networks, the switch hardware cost is increased but the time required to schedule packets is reduced compared to rearrangeably nonblocking switch fabrics. Embodiments of strictly nonblocking switch fabrics with a speedup of two in the middle stage, using the scheduling method 44 of FIG. 5A of time complexity O(s*r), are shown in switch fabric 10 of FIG. 1A and switch fabric 16 of FIG. 1I.

In rearrangeably nonblocking switch fabrics, the switch hardware cost is reduced at the expense of increasing the time required to schedule packets. The scheduling time is increased in a rearrangeably nonblocking network because the paths of already scheduled packets that are disrupted to implement rearrangement need to be scheduled again, in addition to the schedule of the new packet. For this reason, it is desirable to minimize or even eliminate the need for rearrangements of already scheduled packets when scheduling a new packet. When the need for rearrangement is eliminated, that network is strictly nonblocking depending on the number of middle stage interconnection networks and the scheduling method. One embodiment of rearrangeably nonblocking switch fabrics using no speedup in the middle stage is shown in switch fabric 18 of FIG. 1N. It must be noted that the arbitration of generation of requests, issuance of grants, and generating acceptances is performed in only one iteration irrespective of whether the switch fabric is operated in strictly nonblocking manner or in rearrangeably nonblocking manner.

Applicant makes a few observations on output-queued switches. Applicant notes that output-queued switches, by immediately transferring the packets received on input ports to the destination output queues, congest the output ports. For example, in an r*r OQ switch, if all the input ports subscribe to the same output port, then the output port receives packets r times more than the output port is designed to receive. Congestion of output ports create the following unnecessary problems: 1) Additional packet prioritization and management is required in the output ports, 2) Rate guarantees are extremely difficult to implement, 3) Rate of each packet transmitted out of output ports is reduced, 4) It requires randomly dropping packets in the input ports to eliminate the traffic congestion in the output ports, 5) All of these factors to lead to additional traffic management costs, power and memory requirements. Essentially output queuing solves the packet switching only locally by transferring the packets across the fabric, but the goal of deterministic flow of traffic at 100% throughput in the network equipment cannot be achieved.

Also according to the current invention, a direct extension of the speedup required in the middle stage 130 for the switch fabric to be operated in nonblocking manner is proportionately adjusted depending on the number of control bits that are appended to the packets before they are switched to the output ports. For example if additional control bits of 1% are added for every packet or packet segment (where these control bits are introduced only to switch the packets from input to output ports) to be switched from input ports to output ports, the speedup required in the middle stage 130 for the switch fabric is 2.01 to be operated in strictly nonblocking manner and 1.01 to be operated in rearrangeably nonblocking manner.

Similarly according to the current invention, when the packets are segmented and switched to the output ports, the last packet segment may or may not be the same as the packet segment. Alternatively if the packet size is not a perfect multiple of the packet segment size, throughput of the switch fabric would be less than 100%. In embodiments where the last packet segment is frequently smaller than the packet segment size, the speedup in the middle stage needs to be proportionately increased to operate the system at 100% throughput.

The current invention of nonblocking and deterministic switch fabrics can be directly extended to arbitrarily large number of input queues, i.e., with more than one input queue in each input port switching to more than one output queue in the destination output port, and each of the input queues holding a different multirate unicast flow or a group of multirate unicast microflows in all the input ports offer flow by flow QoS with rate and latency guarantees. End-to-end guaranteed bandwidth i.e., for multiple multirate unicast flows in different input queues of an input port to any destination output port can be provided. Moreover guaranteed and constant latency is provided for packet flows from multiple input queues in an input port to any destination output port. Since each input queue in an input port holding different flow but switches packets into the same destined output port, a longer packet from one input queue will not prevent another smaller packet from a second input queue of the same input port switching into the same destination output port, and thus enforcing the latency guarantees of packet flows from the input ports. Here also the switching time of switch fabric determines the latency of the packets in each flow and also the latency of packet segments in each packet.

By increasing the number of multirate unicast flows that are separately switched from input queues into output ports, end to end guaranteed bandwidth and latency can be provided for fine granular flows. Moreover rate weights of unicast flows can also be offered at more granular rates due to the large number of fine granular flows. And also each flow can be individually shaped and if necessary by predictably tail dropping the packets from desired flows under oversubscription and providing the service providers to offer rate and latency guarantees to individual flows and hence enable additional revenue opportunities.

Numerous modifications and adaptations of the embodiments, implementations, and examples described herein will be apparent to the skilled artisan in view of the disclosure.

The embodiments described in the current invention are also useful directly in the applications of parallel computers, video servers, load balancers, and grid-computing applications. The embodiments described in the current invention are also useful directly in hybrid switches and routers to switch both circuit switched time-slots and packet switched packets or cells.

Numerous such modifications and adaptations are encompassed by the attached claims.

1. A system for scheduling multirate unicast packets through an interconnection network having a plurality of input ports and a plurality of output ports, said packets each having a designated output port and rate weight, said system comprising:
a plurality of input queues at each said input port, wherein said input queues have said multirate unicast packets;
means for said each input port to request service from said designated output ports for at most as many said multirate packets equal to the number of input queues at said each input port;
means for each said output port to grant a plurality of requests;
means for each said input port to accept at most as many grants equal to the number of said input queues; and
means for scheduling at most as many said multirate packets equal to the number of input queues from each said input port having accepted grants and to each said output port associated with said accepted grants.

2. The system of claim 1, further comprises:
a plurality of output queues at each said output port, wherein said output queues receive said multirate unicast packets through said interconnection network;
means for each said output port to grant at most as many requests equal to the number of said output queues; and
means for scheduling at most as many said multirate packets equal to the number of input queues from each said input port having accepted grants and at most as many said multirate packets equal to the number of output queues to each said output port associated with said accepted grants.

3. The system of claim 1, wherein said interconnection network is nonblocking interconnection network.

4. The system of claim 3, wherein said nonblocking interconnection network comprises a speedup of at least two.

5. The system of claim 4, wherein said speedup is realized either by,
means of parallelism i.e., by physically replicating said interconnection network at least two times and connected by separate links from each of said input ports and from each of said output ports; or
means of at least two times speedup in link bandwidth between said input ports and said interconnection network, between said output ports and said interconnection network, and also in clock speed of said interconnection network.

6. The system of claim 4,
further is always capable of selecting a path, through said nonblocking interconnection network, for a multirate unicast packet by never changing path of an already selected path for another multirate unicast packet, and said interconnection network is hereinafter “strictly nonblocking network”.

7. The system of claim 3, wherein said nonblocking interconnection network comprises a speedup of at least one.

8. The system of claim 7,
further is always capable of selecting a path, through said nonblocking interconnection network, for a multirate unicast packet if necessary by changing an already selected path of another multirate unicast packet, and said interconnection network is hereinafter “rearrangeably nonblocking network”.

9. The system of claim 1, further comprises memory coupled to said means for scheduling to hold the schedules of already scheduled said packets.

10. The system of claim 2, further comprises memory coupled to said means for scheduling to hold the schedules of already scheduled said packets.

11. The system of claim 1, wherein the arbitration, i.e., said requesting of service by said input ports, said granting of requests by said output ports, and said accepting of grants by input ports, is performed in only one iteration.

12. The system of claim 2, wherein the arbitration, i.e., said requesting of service by said input ports, said granting of requests by said output ports, and said accepting of grants by input ports, is performed in only one iteration.

13. The system of claim 1, wherein said packets are of substantially same size.

14. The system of claim 1, wherein head of line blocking at said input ports is completely eliminated.

15. The system of claim 1, wherein said means for scheduling schedules at most one packet, in a switching time, from each said input queue having accepted grants and to each said output port associated with said accepted grants.

16. The system of claim 2, wherein said means for scheduling schedules at most one packet, in a switching time, from each said input queue having accepted grants and at most one packet to each said output queue associated with said accepted grants.

17. The system of claim 1, is operative so that each said output port, in a switching time, receives at least one packet as long as there is said at least one packet, from any one of said input queues destined to it, and said system is hereinafter “work-conserving system”.

18. The system of claim 2, is operative so that each said output port, in a switching time, receives at least one packet as long as there is said at least one packet, from any one of said input queues destined to it, and said system is hereinafter “work-conserving system”.

19. The system of claim 1, is operative so that each said output port, in a switching time, receives at most one packet even if more than one packet is destined to it irrespective of said speedup in said interconnection network;
whereby said speedup is utilized only to operate said interconnection network in deterministic manner, and never to congest said output ports.

20. The system of claim 2, is operative so that each said output port, in a switching time, receives at most one packet even if more than one packet is destined to it irrespective of said speedup in said interconnection network;
whereby said speedup is utilized only to operate said interconnection network in deterministic manner, and never to congest said output ports.

21. The system of claim 1, is operative so that packets from one of said input queues is always deterministically switched to the destined output port, in the same order as they are received by said input ports in the same path through said interconnection network, and there is never an issue of packet reordering,
whereby switching time is a variable at the design time, offering an option to select it so that a plurality of bytes are switched in each switching time.

22. The system of claim 2, is operative so that packets from one of said input queues is always deterministically switched to one of said output queues in the destined output port, in the same order as they are received by said input ports through said interconnection network, so that no segmentation of said packets in said input ports and no reassembly of said packets in said output ports is required, so that there is never an issue of packet reordering,
whereby switching time is a variable at the design time, offering an option to select it so that a byte or a few bytes are switched in each switching time.

23. The system of claim 1, is operative so that no said arbitration accepted packet at the head of line of each said input queues is held for more than as many switching times equal to said number of input queues at said each input port, and said system is hereinafter “fair system”.

24. The system of claim 2, is operative so that no said arbitration accepted packet at the head of line of each said input queues is held for more than as many switching times equal to said number of input queues at said each input port, and said system is hereinafter “fair system”.

25. The system of claim 1, wherein said interconnection network may be crossbar network, shared memory network, clos network, hypercube network, or any internally nonblocking interconnection network or network of networks.

26. The system of claim 1, wherein said system is operated at 100% throughput.

27. The system of claim 2, wherein said system is operated at 100% throughput.

28. The system of claim 1, wherein said system provides end-to-end guaranteed bandwidth according to said rate weight from any input port to any output port.

29. The system of claim 2, wherein said system provides end-to-end guaranteed bandwidth according to said rate weight from any input port to any output port.

30. The system of claim 1, wherein said system provides guaranteed and constant latency for packets from multiple input ports to any output port.

31. The system of claim 2, wherein said system provides guaranteed and constant latency for packets from multiple input ports to any output port.

32. The system of claim 1, wherein said system does not require internal buffers in said interconnection network and hence is a cut-through architecture.

33. The system of claim 2, wherein said system does not require internal buffers in said interconnection network and hence is a cut-through architecture.

34. A method for scheduling multirate unicast packets through an interconnection network having a plurality of input ports and a plurality of output ports, each said input port comprising a plurality of input queues, and said packets each having at least one designated output port and rate weight, said method comprising:
requesting service for said each input port, from said designated output ports for at most as many said multirate packets equal to the number of input queues at said each input port;
granting requests for each said output port to a plurality of requests;
accepting grants for each said input port at most as many grants equal to the number of said input queues; and
scheduling at most as many said multirate packets equal to the number of input queues from each said input port having accepted grants and to each said output port associated with said accepted grants.

35. The method of claim 34, further comprises:
a plurality of output queues at each said output ports, and;
granting requests for each said output port at most as many requests equal to the number of output queues at each output port; and
scheduling at most as many multirate packets equal to the number of input queues from each said input port having accepted grants and at most as many said multirate packets equal to the number of output queues to each said output port associated with said accepted grants.

36. The method of claim 34, wherein the arbitration, i.e., said requesting of service by said input ports, said granting of requests by said output ports, and said accepting of grants by input ports, is performed in only one iteration.

37. The method of claim 35, wherein the arbitration, i.e., said requesting of service by said input ports, said granting of requests by said output ports, and said accepting of grants by input ports, is performed in only one iteration.

38. The method of claim 34, wherein said packets are of substantially same size.

39. The method of claim 34, wherein head of line blocking at said input ports is completely eliminated

40. The method of claim 34, wherein said scheduling schedules at most one packet, in a switching time, from each said input queue having accepted grants and to each said output port associated with said accepted grants.

41. The method of claim 35, wherein said scheduling schedules at most one packet, in a switching time, from each said input queue having accepted grants and at most one packet to each said output queue associated with said accepted grants.

42. The method of claim 34, is operative so that each said output port, in a switching time, receives at least one packet as long as there is said at least one packet, from any one of said input queues destined to it.

43. The method of claim 35, is operative so that each said output port, in a switching time, receives at least one packet as long as there is said at least one packet, from any one of said input queues destined to it.

44. The method of claim 34, is operative so that each said output port, in a switching time, receives at most one packet even if more than one packet is destined to it irrespective of said speedup in said interconnection network;
whereby speedup in interconnection network is utilized only to operate said interconnection network in deterministic manner, and never to congest said output ports.

45. The method of claim 35, is operative so that each said output port, in a switching time, receives at most one packet even if more than one packet is destined to it irrespective of said speedup in said interconnection network;
whereby said speedup is utilized only to operate said interconnection network in deterministic manner, and never to congest said output ports.

46. The method of claim 34, is operative so that packets from one of said input queues is always deterministically switched to the destined output port, in the same order as they are received by said input ports in the same path through said interconnection network, and there is never an issue of packet reordering,
whereby switching time is a variable at the design time, offering an option to select it so that a plurality of bytes are switched in each switching time.

47. The method of claim 35, is operative so that packets from one of said input queues is always deterministically switched to one of said output queues in the destined output port, in the same order as they are received by said input ports through said interconnection network, so that no segmentation of said packets in said input ports and no reassembly of said packets in said output ports is required, so that there is never an issue of packet reordering,
whereby switching time is a variable at the design time, offering an option to select it so that a plurality of bytes are switched in each switching time.

48. The method of claim 34, is operative so that no said packet at the head of line of each said input queues is held for more than as many switching times equal to said number of input queues at said each input port.

49. The method of claim 35, is operative so that no said packet at the head of line of each said input queues is held for more than as many switching times equal to said number of input queues at said each input port.

50. The method of claim 34, wherein said method schedules said packets at 100% throughput.

51. The method of claim 35, wherein said method schedules said packets at 100% throughput.

52. The method of claim 34, wherein said method is operative so that end-to-end guaranteed bandwidth according to said rate weight from any input port to any output port is provided.

53. The method of claim 35, wherein said method is operative so that end-to-end guaranteed bandwidth according to said rate weight from any input port to any output port is provided.

54. The method of claim 34, wherein said method is operative so that guaranteed and constant latency for packets from multiple input ports to any output port is provided.

55. The method of claim 35, wherein said method is operative so that guaranteed and constant latency for packets from multiple input ports to any output port is provided.

56. A system for scheduling multirate unicast packets through an interconnection network, said system comprising:
r₁ input ports and r₂ output ports, said packets each having a designated output port and rate weight;
r₂ input queues, comprising said packets, at each of said r₁ input ports;
said interconnection network comprising s≧1 subnetworks, and each subnetwork comprising at least one link (hereinafter “first internal link”) connected to each input port for a total of at least r₁ first internal links, each subnetwork further comprising at least one link (hereinafter “second internal link”) connected to each output port for a total of at least r₂ second internal links;
means for said each input port to request service from said designated output ports for at most r₂ said multirate packets from each said input port;
means for each said output port to grant a plurality of requests;
means for each said input port to accept grants to at most r₂ packets; and
means for scheduling at most r₁ said multirate packets in each switching time to be switched in at most r₂ switching times, having accepted grants and to each said output port associated with said accepted grants.

57. The system of claim 56, further comprises:
r₁ output queues at each of said r₂ output ports, wherein said output queues receive multirate unicast packets through said interconnection network;
said interconnection network comprising s≧1 subnetworks, and each subnetwork comprising at least one link (hereinafter “first internal link”) connected to each input port for a total of at least r₁ first internal links, each subnetwork further comprising at least one link (hereinafter “second internal link”) connected to each output port for a total of at least r₂ second internal links;
means for each said output port to grant at most r₁ packets; and
means for scheduling at most r₁ said multirate packets in each switching time to be switched in at most r₂ switching times when r₁≦r₂, and at most r₂ said multirate packets in each switching time to be switched in at most r₁ switching times when r₂≦r₁, having accepted grants and to each said output port associated with said accepted grants.

58. The system of claim 56, wherein said interconnection network is nonblocking interconnection network.

59. The system of claim 58, wherein
$$s \geq \frac{{r}_{1} + {r}_{2} - 1}{MAX ( {r}_{1} , {r}_{2} )} ≅ 2$$
subnetworks and
said system further is always capable of selecting a path, through said nonblocking interconnection network, for a multirate unicast packet by never changing path of an already selected path for another multirate unicast packet, and said interconnection network is hereinafter “strictly nonblocking network”.

60. The system of claim 58, wherein s≧1 subnetworks,
both the first internal links and the second internal links are operated at least two times faster than the peak rate of each packet received at said input queues; and
said subnetwork is operated at least two times faster than the peak rate of each packet received at said input queues; and
said system further is always capable of selecting a path, through said nonblocking interconnection network, for a multirate unicast packet by never changing path of an already selected path for another multirate unicast packet, and said interconnection network is hereinafter “strictly nonblocking network”.

61. The system of claim 58, wherein
$$s \geq \frac{{r}_{2}}{{r}_{2}} = 1$$
subnetworks and
both said first internal links and said second internal links are operated at, at least as fast as the peak rate of each packet received at said input queues; and
said subnetwork is operated at least as fast as the peak rate of each packet received at said input queues; and
said system further is always capable of selecting a path, through said nonblocking interconnection network, for a multirate unicast packet if necessary by changing an already selected path of another multirate unicast packet, and said interconnection network is hereinafter “rearrangeably nonblocking network”.

62. The system of claim 56, further comprises memory coupled to said means for scheduling to hold the schedules of already scheduled said packets.

63. The system of claim 57, further comprises memory coupled to said means for scheduling to hold the schedules of already scheduled said packets.

64. The system of claim 56, wherein the arbitration, i.e., said requesting of service by said input ports, said granting of requests by said output ports, and said accepting of grants by input ports, is performed in only one iteration.

65. The system of claim 57, wherein the arbitration, i.e., said requesting of service by said input ports, said granting of requests by said output ports, and said accepting of grants by input ports, is performed in only one iteration.

66. The system of claim 56, wherein r₁=r₂=r and said means for scheduling schedules at most r packets in each switching time to be switched in at most r switching times, having accepted grants and to each said output port associated with said accepted grants.

67. The system of claim 57, wherein r₁=r₂=r and said means for scheduling schedules at most r packets in each switching time to be switched in at most r switching times, having accepted grants and to each said output port associated with said accepted grants.

68. The system of claim 56, wherein said packets are of substantially same size.

69. The system of claim 56, wherein head of line blocking at said input ports is completely eliminated.

70. The system of claim 56, wherein said means for scheduling schedules at most one packet, in a switching time, from each said input queue having accepted grants and to each said output port associated with said accepted grants.

71. The system of claim 57, wherein said means for scheduling schedules at most one packet, in a switching time, from each said input queue having accepted grants and at most one packet to each said output queue associated with said accepted grants.

72. The system of claim 56, is operative so that each said output port, in a switching time, receives at least one packet as long as there is said at least one packet, from any one of said input queues destined to it, and said system is hereinafter “work-conserving system”.

73. The system of claim 57, is operative so that each said output port, in a switching time, receives at least one packet as long as there is said at least one packet, from any one of said input queues destined to it, and said system is hereinafter “work-conserving system”.

74. The system of claim 56, is operative so that each said output port, in a switching time, receives at most one packet even if more than one packet is destined to it irrespective of said speedup in said interconnection network;
whereby said speedup is utilized only to operate said interconnection network in deterministic manner, and never to congest said output ports.

75. The system of claim 57, is operative so that each said output port, in a switching time, receives at most one packet even if more than one packet is destined to it irrespective of said speedup in said interconnection network;
whereby said speedup is utilized only to operate said interconnection network in deterministic manner, and never to congest said output ports.

76. The system of claim 56, is operative so that packets from one of said input queues is always deterministically switched to the destined output port, in the same order as they are received by said input ports in the same path through said interconnection network, and there is never an issue of packet reordering,
whereby switching time is a variable at the design time, offering an option to select it so that a plurality of bytes are switched in each switching time.

77. The system of claim 57, is operative so that packets from one of said input queues is always deterministically switched to one of said output queues in the destined output port, in the same order as they are received by said input ports through said interconnection network, so that no segmentation of said packets in said input ports and no reassembly of said packets in said output ports is required, so that there is never an issue of packet reordering,
whereby switching time is a variable at the design time, offering an option to select it so that a plurality of bytes are switched in each switching time.

78. The system of claim 56, is operative so that no said packet at the head of line of each said input queues is held for more than as many switching times equal to said number of input queues at said each input port, and said system is hereinafter “fair system”.

79. The system of claim 57, is operative so that no said packet at the head of line of each said input queues is held for more than as many switching times equal to said number of input queues at said each input port, and said system is hereinafter “fair system”.

80. The system of claim 56, wherein said interconnection network may be crossbar network, shared memory network, clos network, hypercube network, or any internally nonblocking interconnection network or network of networks.

81. The system of claim 56, wherein said system is operated at 100% throughput.

82. The system of claim 57, wherein said system is operated at 100% throughput.

83. The system of claim 56, wherein said system provides end-to-end guaranteed bandwidth according to said rate weight from any input port to any output port.

84. The system of claim 57, wherein said system provides end-to-end guaranteed bandwidth according to said rate weight from any input port to any output port.

85. The system of claim 56, wherein said system provides guaranteed and constant latency for packets from multiple input ports to any output port.

86. The system of claim 57, wherein said system provides guaranteed and constant latency for packets from multiple input ports to any output port.

87. The system of claim 56, wherein said system does not require internal buffers in said interconnection network and hence is a cut-through architecture.

88. The system of claim 57, wherein said system does not require internal buffers in said interconnection network and hence is a cut-through architecture.

89. A method for scheduling multirate unicast packets through an interconnection network having,
r₁ input ports and r₂ output ports, said packets each having at least one designated output port and rate weight;
r₂ input queues, comprising said packets, at each of said r₁ input ports;
said interconnection network comprising s≧1 subnetworks, and each subnetwork comprising at least one link (hereinafter “first internal link”) connected to each input port for a total of at least r₁ first internal links, each subnetwork further comprising at least one link (hereinafter “second internal link”) connected to each output port for a total of at least r₂ second internal links, said method comprising:
requesting service for said each input port from said designated output ports for at most r₂ said multirate packets;
granting requests for each said output port to a plurality of requests;
accepting grants for each said input port at most r₂ packets; and
scheduling at most r₁ said multirate packets in each switching time to be switched in at most r₂ switching times, having accepted grants and to each said output port associated with said accepted grants.

90. The method of claim 89, further comprises:
r₁ output queues at each of said r₂ output ports, wherein said output queues receive multirate unicast packets through said interconnection network;
said interconnection network comprising s≧1 subnetworks, and each subnetwork comprising at least one link (hereinafter “first internal link”) connected to each input port for a total of at least r₁ first internal links, each subnetwork further comprising at least one link (hereinafter “second internal link”) connected to each output port for a total of at least r₂ second internal links;
granting requests for each said output port to at most r₁ packets; and
scheduling at most r₁ said multirate packets in each switching time to be switched in at most r₂ switching times when r₁≦r₂, and at most r₂ said multirate packets in each switching time to be switched in at most r₁ switching times when r₂≦r₁, having accepted grants and to each said output port associated with said accepted grants.

91. The method of claim 89, wherein the arbitration, i.e., said requesting of service by said input ports, said granting of requests by said output ports, and said accepting of grants by input ports, is performed in only one iteration.

92. The method of claim 90, wherein the arbitration, i.e., said requesting of service by said input ports, said granting of requests by said output ports, and said accepting of grants by input ports, is performed in only one iteration.

93. The method of claim 89, wherein r₁=r₂=r and said scheduling schedules at most r packets in each switching time to be switched in at most r switching times, having accepted grants and to each said output port associated with said accepted grants.

94. The method of claim 90, wherein r₁=r₂=r and said scheduling schedules at most r packets in each switching time to be switched in at most r switching times, having accepted grants and to each said output port associated with said accepted grants.

95. The method of claim 89, wherein said packets are of substantially same size.

96. The method of claim 89, wherein head of line blocking at said input ports is completely eliminated.

97. The method of claim 89, is operative wherein said scheduling schedules at most one packet, in a switching time, from each said input queue having accepted grants and to each said output port associated with said accepted grants.

98. The method of claim 90, is operative wherein said scheduling schedules at most one packet, in a switching time, from each said input queue having accepted grants and at most one packet to each said output queue associated with said accepted grants.

99. The method of claim 89, is operative so that each said output port, in a switching time, receives at least one packet as long as there is said at least one packet, from any one of said input queues destined to it.

100. The method of claim 90, is operative so that each said output port, in a switching time, receives at least one packet as long as there is said at least one packet, from any one of said input queues destined to it.

101. The method of claim 89, is operative so that each said output port, in a switching time, receives at most one packet even if more than one packet is destined to it irrespective of said speedup in said interconnection network;
whereby speedup in interconnection network is utilized only to operate said interconnection network in deterministic manner, and never to congest said output ports.

102. The method of claim 90, is operative so that each said output port, in a switching time, receives at most one packet even if more than one packet is destined to it irrespective of said speedup in said interconnection network;
whereby said speedup is utilized only to operate said interconnection network in deterministic manner, and never to congest said output ports.

103. The method of claim 89, is operative so that packets from one of said input queues is always deterministically switched to the destined output port, in the same order as they are received by said input ports in the same path through said interconnection network, and there is never an issue of packet reordering,
whereby switching time is a variable at the design time, offering an option to select it so that a plurality of bytes are switched in each switching time.

104. The method of claim 90, is operative so that packets from one of said input queues is always deterministically switched to one of said output queues in the destined output port, in the same order as they are received by said input ports through said interconnection network, so that no segmentation of said packets in said input ports and no reassembly of said packets in said output ports is required, so that there is never an issue of packet reordering,
whereby switching time is a variable at the design time, offering an option to select it so that a plurality of bytes are switched in each switching time.

105. The method of claim 89, is operative so that no said packet at the head of line of each said input queues is held for more than as many switching times equal to said number of input queues at said each input port.

106. The method of claim 90, is operative so that no said packet at the head of line of each said input queues is held for more than as many switching times equal to said number of input queues at said each input port.

107. The method of claim 89, wherein said method schedules said packets at 100% throughput.

108. The method of claim 90, wherein said method schedules said packets at 100% throughput.

109. The method of claim 89, wherein said method is operative so that end-to-end guaranteed bandwidth according to said rate weight from any input port to any output port is provided.

110. The method of claim 90, wherein said method is operative so that end-to-end guaranteed bandwidth according to said rate weight from any input port to any output port is provided.

111. The method of claim 89, wherein said method is operative so that guaranteed and constant latency for packets from multiple input ports to any output port is provided.

112. The method of claim 90, wherein said method is operative so that guaranteed and constant latency for packets from multiple input ports to any output port is provided.
